(19) United States
(12) Patent Application Publication
(10) Pub. No.: US 2024/0276426 A1
(43) Pub. Date: Aug. 15, 2024

(54) METHOD AND APPARATUS FOR SUPPORTING POSITIONING SERVICE OF USER EQUIPMENT IN RRC INACTIVE STATE IN WIRELESS COMMUNICATION SYSTEM

(71) Applicant: Samsung Electronics Co., Ltd., Suwon-si (KR)

(72) Inventors: Beomsik BAE, Suwon-si (KR); Taeseop LEE, Suwon-si (KR)

(21) Appl. No.: 18/438,348

(22) Filed: Feb. 9, 2024

(30) Foreign Application Priority Data
Feb. 13, 2023 (KR) 10-2023-0018871

(51) Int. Cl. H04W 64/00; H04L 5/00

(52) U.S. Cl. CPC H04W 64/00; H04L 5/0051

(57) ABSTRACT

The disclosure relates to a 5G or 6G communication system for supporting a higher data transmission rate. A method performed by an location management function (LMF) entity in a wireless communication system, the method comprising: identifying a validity area associated with requested sounding reference signal (SRS) configuration information for a user equipment (UE), transmitting, to a first base station, a first message including information on the validity area, and receiving, from the first base station, a second message including SRS configuration information associated with the validity area.

### CROSS-REFERENCE TO RELATED APPLICATION

This application is based on and claims priority under 35 U. S.C. § 119 to Korean Patent Application No. 10-2023-0018871, filed on Feb. 13, 2023, in the Korean Intellectual Property Office, the disclosure of which is herein incorporated by reference in its entirety.

### BACKGROUND

### 1. Field

The disclosure relates to a wireless communication system and, more specifically, to a method and an apparatus for supporting a positioning service in a user equipment (UE) in a radio resource control (RRC) inactive state in a wireless communication system.

### 2. Description Of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure provides a method and an apparatus for supporting a positioning service by a UE in a radio resource control (RRC) inactive state in wireless communication system, and effectively provides the service.

The technical problems to be solved in the disclosure are not limited to the technical problems to mentioned above, and other technical problems that are not mentioned can be clearly understood by those skilled in the art to which the disclosure belongs from the description below.

An operation method of a base station in a wireless communication system according to an embodiment of the disclosure may include receiving request message of a positioning service from a location management function (LMF), transmitting, to a user equipment and the LMF, configuration information of an uplink sounding reference signal (SRS), based on the request message, performing measurement of the uplink SRS, based on the SRS configuration information, and transmitting, to the LMF, information including a result of the measurement of the uplink SRS, and the user equipment is in an RRC inactive state.

The disclosure provides a device and a method capable of effectively providing a service in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system for providing a positioning service according to various embodiments of the present disclosure;

FIG. 2 illustrates a flow of a signal for providing a positioning service by using an uplink SRS transmitted by a user equipment in an RRC inactive state according to various embodiments of the present disclosure;

FIG. 3 illustrates an operation order of an LMF according to various embodiments of the present disclosure;

FIG. 4A illustrates a configuration of an information element (IE) included in an NRPPa positioning information request message and an NRPPa positioning information request message according to various embodiments of the present disclosure;

FIG. 4B illustrates a configuration of an IE included in an NRPPa positioning information request message and an NRPPa positioning information request message according to various embodiments of the present disclosure;

FIG. 4C illustrates a configuration an IE included in an NRPPa positioning information request message and an NRPPa positioning information request message according to various embodiments of the present disclosure;

FIG. 4D illustrates a configuration of an IE included in an NRPPa positioning information request message and an NRPPa positioning information request message according to various embodiments of the present disclosure;

FIG. 4E illustrates a configuration of an IE included in an NRPPa positioning information request message and an NRPPa positioning information request message according to various embodiments of the present disclosure;

FIG. 4F illustrates a configuration of an IE included in an NRPPa positioning information request message and an NRPPa positioning information request message according to various embodiments of the present disclosure;

FIG. 5A illustrates a configuration of an IE included in an NRPPa positioning information update message and an NRPPa positioning information update message according to various embodiment of the present disclosure;

FIG. 5B illustrates a configuration of an IE included in an NRPPa positioning information update message and an NRPPa positioning information update message according to various embodiment of the present disclosure;

FIG. 6A illustrates a configuration of an IE included in an NRPPa measurement request message and an NRPPa measurement request message according to various embodiments of the present disclosure;

FIG. 6B illustrates a configuration of an IE included in an NRPPa measurement request message and an NRPPa measurement request message according to various embodiments of the present disclosure;

FIG. 7 illustrates a flow of a signal for providing a positioning service by using an uplink SRS transmitted by a user equipment in an RRC inactive state according to various embodiment of the present disclosure;

FIG. 8 illustrates a flow of a signal for providing a positioning service by using an uplink SRS transmitted by a user equipment in an RRC inactive state according to various embodiments of the present disclosure;

FIG. 9 illustrates an operation order of an LMF according to various embodiments of the present disclosure;

FIG. 10 illustrates a configuration of a message related to an NRPPa SRS pre-configuration request procedure and an IE included in the message related to the NRPPa SRS pre-configuration request procedure according to various embodiments of the present disclosure;

FIG. 11 illustrates a flow of a signal for providing a positioning service by using an uplink SRS transmitted by a user equipment in an RRC inactive state according to various embodiments of the present disclosure;

FIG. 12 illustrates a configuration of a message related to an Xn SRS pre-configuration request procedure and an IE included in the message related to the Xn SRS pre-configuration request procedure according to various embodiments of the present disclosure;

FIG. 13 illustrates a flow of a signal in a case where a serving base station has released an uplink SRS configuration of a user equipment according to various embodiments of the present disclosure;

FIG. 14 illustrates a flow of a signal in a case where a serving base station has released an uplink SRS configuration of a user equipment according to various embodiments of the present disclosure;

FIG. 15 illustrates a configuration of an NRPPa SRS pre-configuration release request message according to various embodiments of the present disclosure;

FIG. 16 illustrates an improved signal flow in a positioning activation procedure according to various embodiments of the present disclosure;

FIG. 17 illustrates a configuration of an NRPPa positioning information request message according to various embodiments of the disclosure;

FIG. 18 illustrates a configuration of an NRPPa positioning information response message according to various embodiments of the present disclosure;

FIG. 19 illustrates a configuration of an NRPPa positioning information update message according to various embodiments of the present disclosure;

FIG. 20 illustrates an improved signal flow of a signal procedure in a procedure of transmitting an NRPPa positioning activation request to a last serving base station by an LMF in an RRC inactive state according to various embodiments of the present disclosure;

FIG. 21A illustrates a configuration of an Xn retrieve UE context response message according to various embodiments of the present disclosure;

FIG. 21B illustrates a configuration of an Xn retrieve UE context response message according to various embodiments of the present disclosure;

FIG. 21C illustrates a configuration of an Xn retrieve UE context response message according to various embodiments of the present disclosure;

FIG. 22 illustrates an internal structure of a base station according to various embodiments of the present disclosure; and

FIG. 23 illustrates a configuration of a terminal according to various embodiments of the disclosure.

### DETAILED DESCRIPTION

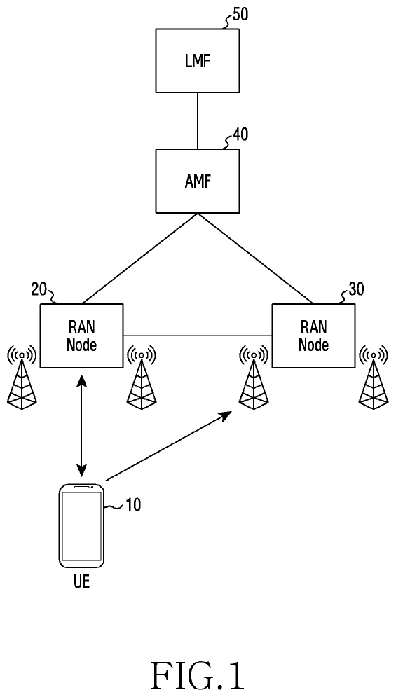

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art to which the disclosure pertains and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to new radio (NR) as a radio access network and Packet Core (5G system, 5G Core Network, or next generation core (NG Core)) as a core network, which are specified in the 5G mobile communication standards defined by the 3rd generation partnership project (3GPP) that is a mobile communication standardization group, but based on determinations by those skilled in the art, the main idea of the disclosure may be applied to other communication systems having similar backgrounds or channel types through some modifications without significantly departing from the scope of the disclosure.

In the following description, some of terms and names defined in the 3GPP standards (standards for 5G, NR, LTE, or similar systems) will be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Further, according to some embodiments, the “unit” may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) {or a mobile station (MS)} transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also requires a design for assigning a large number of resources in a frequency band in order to secure reliability of a communication link. However, the above-described mMTC, URLLC, and eMBB are only examples of different types of services, and service types to which the disclosure is applicable are not limited to the above-described examples.

The three 5G services, that is, eMBB, URLLC, and mMTC, may be multiplexed and transmitted in a single system. In order to satisfy different requirements of the respective services, different transmission/reception techniques and transmission/reception parameters may be used between the services. Of course, the 5G is not limited to the above-mentioned three services.

In providing a positioning service of a user equipment (U) in a mobile communication, the disclosed embodiment provides a method of determining, if the positioning service is provided using an uplink sounding reference signal (SRS) transmitted by the user equipment even when the user equipment is in a radio resource control (RRC) inactive state, a validity area in which uplink sounding reference signal (SRS) configuration information received while a user equipment transitions to an RRC inactive state can be continuously used even when a cell in which the user equipment is located is changed as the user equipment moves, and performing signaling In addition, a method of improving a signal procedure in a mobile communication network (or a wireless communication network) related to the positioning service in the RRC inactive state of the user equipment and reducing occurrence and delay of unnecessary signals is provided. Hereinafter, embodiments of the disclosure are applicable to a 5G communication system (5G wireless communication system or 5G system). However, the embodiments of the disclosure are applied not only to the 5G system, and may be also applicable to a 4G or NR communication system.

FIG. 1 illustrates a structure of a mobile communication system (or wireless communication system) for providing a positioning service according to various embodiments of the present disclosure.

Referring to FIG. 1, radio access network (RAN) nodes (e.g., BS) 20 and 30 specified in a communication system structure for providing a positioning service may be mobile communication base stations connected to a core network (CN) 70 such as a 5G core network (5GC), and may be mobile communication base stations directly connected to an access and mobility management function (AMF) 40 included in the 5GC. For example, the RAN node 30 may be an NR gNB, etc. A user equipment (UE) 10 may communicate with the RAN node 20 (e.g., BS) of a cell in which the UE 10 is located. In addition, neighboring RAN nodes 30 of the cell in which the UE 10 is located may receive an uplink signal (for example, an uplink SRS signal) for transmitted by the UE 10 for positioning, and the uplink signal (for example, the uplink SRS signal) transmitted by the UE 10 for positioning may be utilized as information for the positioning service. In this case, the positioning service may refer to a service for calculating the location of the UE. The RAN nodes 20 and 30 may perform communication between RAN nodes by using an interface (for example, an Xn interface) between base stations.

A location management function (LMF) 50 is a function of a core network for the purpose of providing a positioning service for calculating the location of the UE, and may be connected to an AMF 40 to communicate with the RAN nodes 20 and 30 and the UE 10 through the AMF and provide the positioning service. The RAN nodes 20 and 30 and the AMF 40 of the core network may communicate with each other by using an interface (for example, an NG interface) between the RAN node and the core network. The AMF 40 may use a positioning-related protocol (for example, NR positioning protocol A (NRPPa) when communicating with the location management function (LMF) 50 and the RAN nodes 30 and 40, and a positioning-related protocol message (for example, an NRPPa message) may be included in an interface (for example, NG interface) message used for connection between the RAN nodes 20 and 30 and the core network and transmitted.

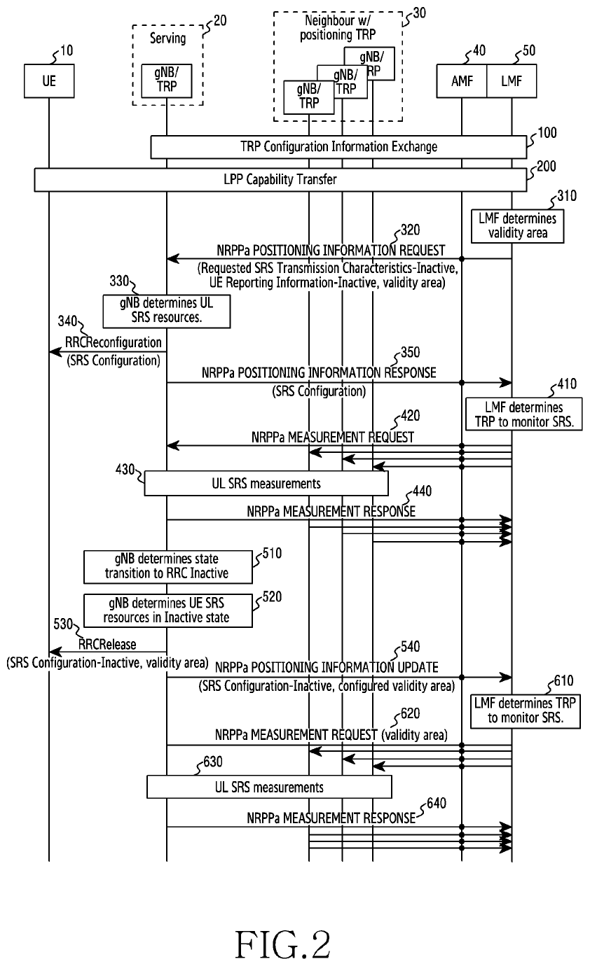

FIG. 2 illustrates a flow of a signal for providing a positioning service by using an uplink SRS transmitted by a user equipment in an RRC inactive state according to various embodiments of the present disclosure.

Referring to FIG. 2, when a positioning service is provided using an uplink SRS of a user terminal in an RRC inactive state, an LMF may determine a validity area in which uplink SRS configuration information received while the user equipment transitions to an RRC inactive state can be continuously used even when a cell in which the user equipment is located is changed as the user equipment moves, and the user equipment may transfer the same to serving base stations (for example, gNB or transmission and reception point (TRP)). In addition, a method in which the serving base station of the user equipment again transfers the same to the user equipment and a signaling procedure may be described.

In operation 100, an LMF 50 may perform a procedure of receiving information on a TRP for a positioning service from a base station (for example, NR gNB or LTE eNB), and messages required for the procedure of receiving the TRP information for the positioning service may be transmitted and/or received through an AMF 40.

In operation 111, the LMF 50 may request positioning capability information of the terminal 10 through an LPP capability transfer procedure with the user equipment 10, and receive the positioning capability information from the user equipment. When the LMF 50 determines to use a positioning service method using an uplink SRS in the user equipment 10 and starts a related procedure, the LMF 50 may determine a validity area related to transmission of the uplink SRS in operation 310.

In operation 320, the LMF 50 may transmit an NRPPa positioning information request message to a serving base station 20 of the user equipment through the AMF 40. The NRPPa positioning information request message may include, as information for requesting an uplink SRS configuration to be used by the user equipment, at least one of requested SRS transmission characteristics information and UE reporting information. In addition, the NRPPa positioning information request message may further include, as information for requesting an uplink SRS configuration to be used in the RRC inactive state by the user equipment, at least one of requested SRS transmission characteristics-inactive information and UE reporting information-inactive information, and if there is no additional information related to the RRC inactive state, the serving base station 20 may perform SRS configuration with reference to at least one of requested SRS transmission characteristics information and UE reporting information, without distinguishing between an RRC-connected state and the RRC inactive state. In addition, information on the validity area determined in operation 310 by the LMF 50 may be included in the NRPPa positioning information request message and the message may be transferred to the serving base station 20.

In operation 320, the serving base station 20 having received the NRPPa positioning information request message from the LMF 50 may determine, based on the information included in the NRPPa positioning information request message, a resource to be used for uplink SRS (UL-SRS) transmission by the user equipment 10 in operation 330, and may transfer an RRC message including the information related to the uplink SRS transmission to the user equipment 10 in operation 340. In addition, in operation 350, the serving base station 20 may transfer the NRPPa positioning information request message including the uplink SRS configuration information transferred to the LMF 50 through the AMF 40.

When receiving the NRPPa positioning information request message transferred from the serving base station 20, the LMF 50 may determine at least one 20 or 30 of a base station, cell, or a TRP for monitoring an uplink SRS transmitted by the user equipment in operation 410. The LMF 50 may request uplink SRS monitoring of the user equipment by transmitting an NRPPa measurement request message to each base station through the AMF 40 as in operation 420. If, although not shown in FIG. 2, the uplink SRS transmission is not configured as persistent transmission and is configured as semi-persistent SRS transmission or aperiodic SRS transmission, the LMF 50 may need a procedure of transmitting an NRPPa positioning activation request message to the base station 20 and requesting activation of the SRS transmission of the user equipment. The base stations 20 and 30 may monitor the uplink SRS according to the information included in the NRPPa measurement request message received in operation 420, and then transfer a result of the monitoring to the LMF 50 through the AMF 40 by using an NRPPa measurement response message as in operation 440. For example, information included in the NRPPa measurement response message may be used to calculate location information of the user equipment by the LMF 50.

As in operation 510, if the serving base station 20 determines to cause the corresponding user equipment 10 to transition to the RRC inactive state, the serving base station may determine, in operation 520, a resource to be used for uplink SRS (UL-SRS) transmission in the RRC inactive state by the user equipment 10 by using at least one of requested SRS transmission characteristics information and UE reporting information from the LMF 50, which are required for the positioning service in the RRC inactive state by the user equipment.

In operation 530, the serving base station may transfer an RRC message including the information related to the uplink SRS transmission to the user equipment 10. In this case, the serving base station 20 may also transfer validity area information to the user equipment. The serving base station 20 may determine again a validity area to be configured for the user equipment within the validity area transferred from the LMF 50 in operation 320. Alternatively, the serving base station 20 may use the validity area transferred from the LMF 50, or may configure the same validity area for the user equipment. When the user equipment 10 moves to a cell (or base station) within the validity area in the RRC inactive state, the user equipment may determine that the uplink SRS configuration information received in operation 530 is continuously valid and perform uplink SRS transmission.

In operation 540, the serving base station 20 may transfer an NRPPa positioning information update message to the LMF 50 through the AMF 40 by including uplink SRS configuration information transferred to the user equipment and validity area information configured for the user equipment. The uplink SRS configuration information included in the message in operation 540 may be transferred by including a distinguisher corresponding to SRS configuration information used by the user equipment in the RRC inactive state, or including the SRS configuration information by using a name different from the existing uplink SRS configuration information. In addition, if the validity area information is not included in the message in operation 540, the LMF 50 may determine that the serving base station 20 has transferred the validity area transferred to the serving base station in operation 320 to the user equipment 10 without change, and may further include an indicator for indicating whether the validity area has been used.

When receiving the NRPPA positioning information update message from the serving base station 20, the LMF 50 may determine, in operation 610, a base station (or TRP) 20 or 30 for monitoring the uplink SRS transmitted by the user equipment. The LMF 50 may request uplink SRS monitoring of the user equipment by transmitting the NRPPa measurement request message to each base station through the AMF 40 as in operation 620. In this case, the LMF 50 may include validity area information in the NRPPa measurement request message to assist uplink SRS reception transmitted by the user equipment in each base station. The base stations 20 and 30 may monitor the uplink SRS according to information included in the NRPPa measurement request message received in operation 620, and then transfer a result of the monitoring to the LMF 50 through AMF 40 by using the NRPPa measurement response message as in operation 640. Information included in the NRPPa measurement response message may be used to calculate location information of the user equipment by the LMF 50.

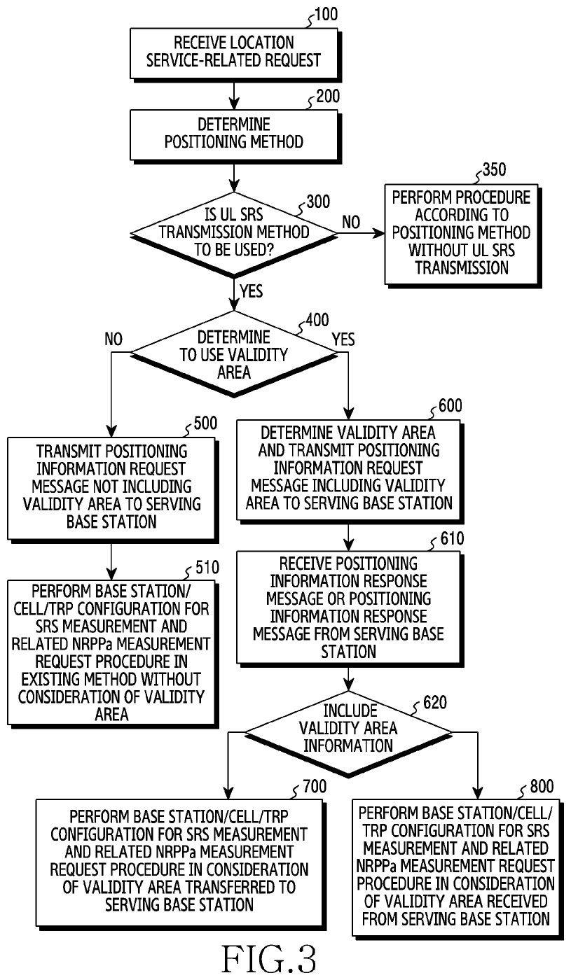

FIG. 3 illustrates an operation order of an LMF according to various embodiments of the present disclosure.

Referring to FIG. 3, in operation 100, when receiving a request related to a location information service of a user equipment, an LMF (for example, the LMF 50 of FIG. 2) may determine a positioning method required to calculate location information of the user equipment, as in operation 200. In operation 100, the LMF may receive at least one of a user equipment request, request from another 5G core network entity, or a user equipment location information service request from an application server or the like.

In operation 300, the LMF may determine whether to use an uplink SRS (UL-SRS).

In operation 350, when the LMF determines to use a positioning method other than the method using an SRS (UL-SRS), the LMF may perform a procedure according to the positioning method selected as in operation 350.

In operation 400, when the LMF determines to use the method using an uplink SRS (UL-SRS), the LMF may determine whether to use a validity area.

In operation 500, when the LMF determines to use a positioning method using the uplink SRS, without using the validity area, the LMF may transmit a positioning information request message not including the validity area to the serving base station through the AMF.

In operation 510, the LMF may perform configuration for at least one of a base station, a cell, or a TRP for uplink SRS measurement and a related NRPPa measurement request procedure, without consideration of the validity area.

In operation 600, when determining to use the positioning method using the uplink SRS while using the validity area, the LMF may determine a validity area and transmit an NRPPa positioning information request message including the validity area to the serving base station.

In operation 610, the LMF receive at least one of the NRPPa positioning information response message and the NRPPa positioning information response message from the serving base station.

In operation 620, the LMF may identify whether the message received from operation 610 includes validity area information.

In operation 700, when the validity area is not included, the LMF may perform configuration for at least one of a base station, a cell, or a TRP for SRS measurement and perform a related NRPPa measurement request procedure in consideration of the validity area transferred to the serving base station in operation 600.

In operation 800, when the validity area is included, the LMF may perform configuration for at least one of a base station, a cell, or a TRP for SRS measurement and perform a related NRPPa measurement request procedure in consideration of the received validity area.

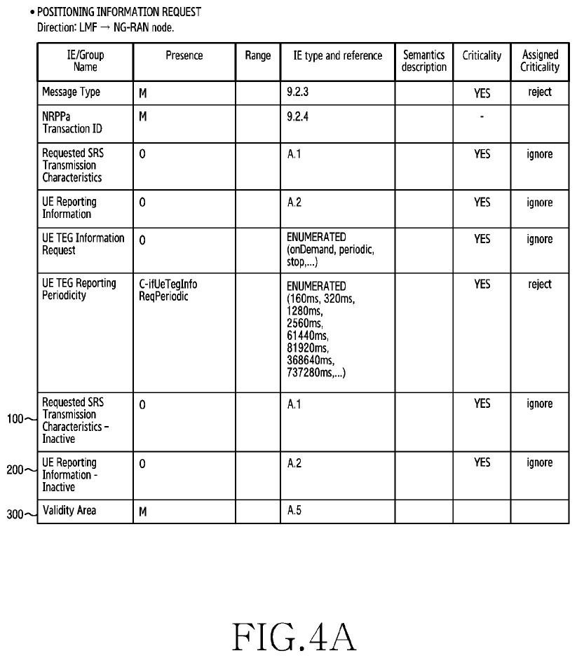

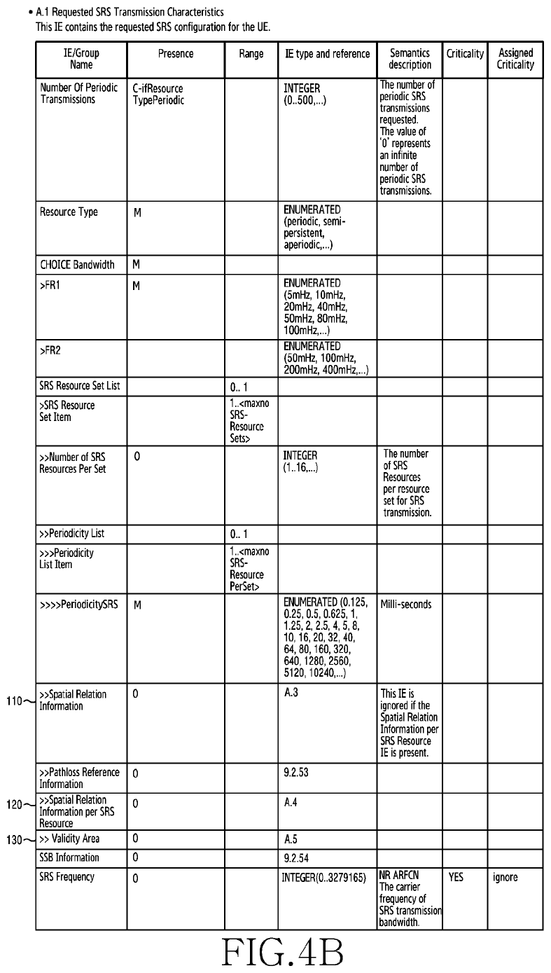

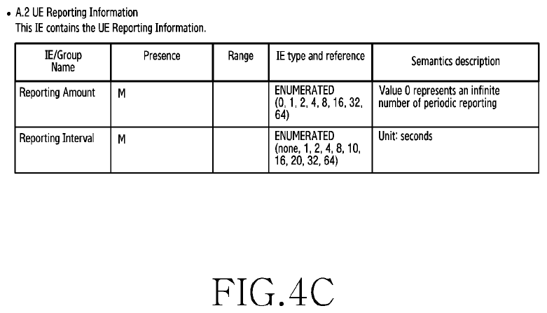

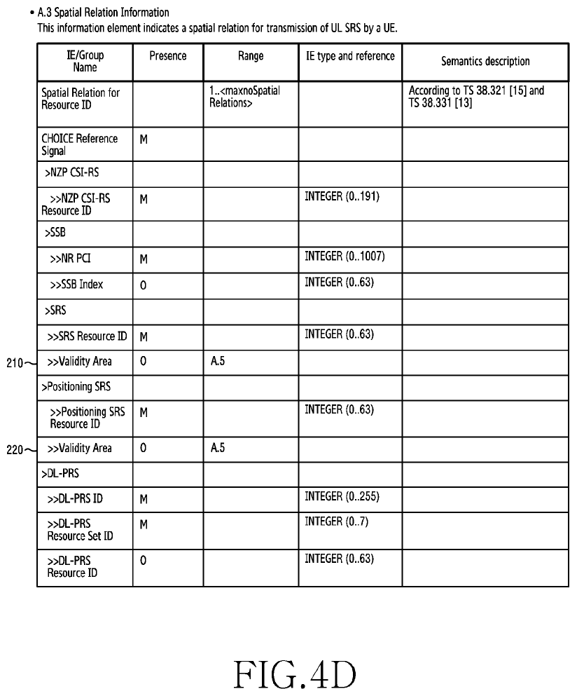

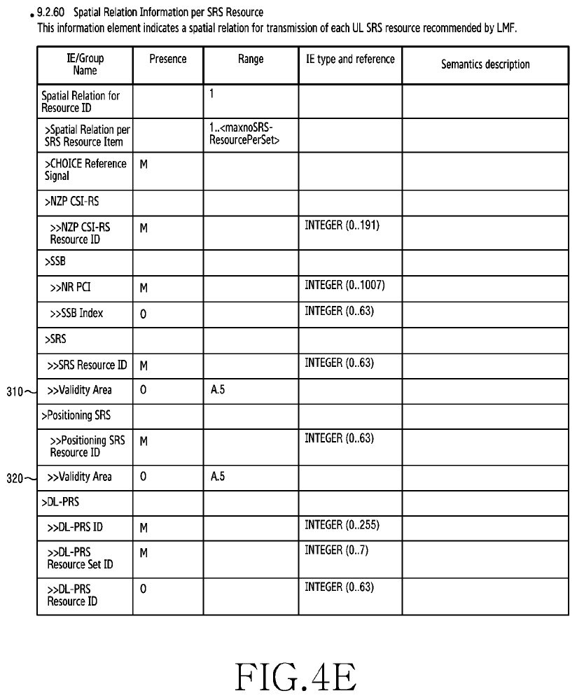

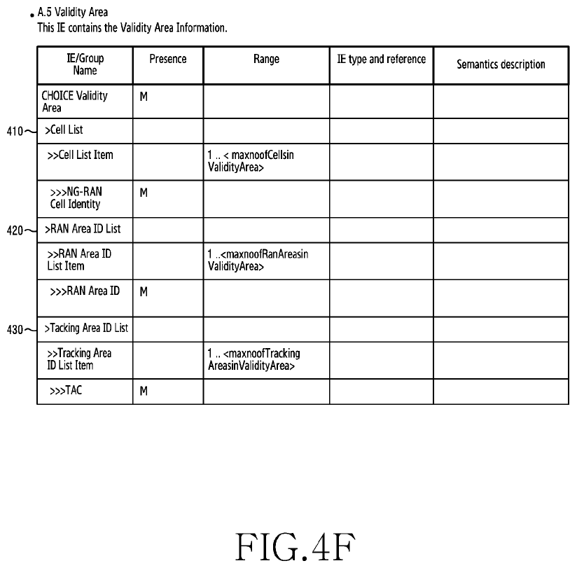

FIG. 4A illustrates a configuration of an information element (IE) included in an NRPPa positioning information request message and an NRPPa positioning information request message according to various embodiments of the present disclosure, FIG. 4B illustrates a configuration of an IE included in an NRPPa positioning information request message and an NRPPa positioning information request message according to various embodiments of the disclosure, FIG. 4C illustrates a configuration an IE included in an NRPPa positioning information request message and an NRPPa positioning information request message according to various embodiments of the disclosure, FIG. 4D illustrates a configuration of an IE included in an NRPPa positioning information request message and an NRPPa positioning information request message according to various embodiments of the disclosure, FIG. 4E illustrates a configuration of an IE included in an NRPPa positioning information request message and an NRPPa positioning information request message according to various embodiments of the disclosure, and FIG. 4F illustrates a configuration of an IE included in an NRPPa positioning information request message and an NRPPa positioning information request message according to various embodiments of the disclosure.

Referring to FIGS. 4A to 4F, an example of a configuration of each IE included in an NRPPa positioning information request message (for example, the message in operation 320 of FIG. 2) and an NRPPa positioning information request message transferred to a base station through an AMF by an LMF, used in operation 320 of FIG. 2, may be described. The term of the IE included in FIGS. 4A to 4F is merely provided as an example, and another name having the same function may be also used.

FIG. 4A illustrates an example of a configuration of an NRPPa positioning information request message, and the NRPPa positioning information request message may include information required for configuration for transmitting an uplink SRS by a user equipment in an RRC inactive state, in addition to the existing requested SRS transmission characteristics IE and a UE reporting information IE. In an embodiment, as indicated in operations 200 and 300 of FIG. 4A, information to be used in the RRC inactive state may be distinguished and transferred like a requested SRS transmission characteristics-inactive IE and a UE reporting information-inactive IE. In addition, in an embodiment, a message may be configured so that information indicated in operations 200 and 300 of FIG. 4A is included in the existing requested SRS transmission characteristics IE and UE reporting information IE. If the information to be used in the RRC inactive state is not distinguished and transferred, a base station may determine, using the requested SRS transmission characteristics IE and the UE reporting information IE information, a configuration for transmitting the uplink SRS by the user equipment in the RRC inactive state.

The NRPPa positioning information request message may include validity area IE information indicating the area in which the user equipment may determine that configuration information for transmitting the uplink SRS by the user equipment in the RRC inactive state is valid and use the same. The validity area may be determined in the following levels and transferred. However, the method described below is merely provided as one embodiment, and the validity area may be configured according to other methods not described below and transferred.
1. A user equipment level:
Included as indicated in 300 of FIG. 4a.
2. For each SRS resource set:
Included in requested SRS transmission characteristics IE indicated in 100 of FIG. 4A, and included as indicated in 130 of FIG. 4B.
3. For each SRS resource ID:
Included in requested SRS transmission characteristics IE indicated in 100 of FIG. 4A, and included in spatial relation information IE indicated in 110 of FIG. 4B, as indicated in 210 of FIG. 4D, or
Included in requested SRS transmission characteristics IE indicated in 100 of FIG. 4A, and included in spatial relation information per SRS resource IE indicated in 120 of FIG. 4B, as indicated in 310 of FIG. 4E
4. For each positioning SRS resource ID:
Included in requested SRS transmission characteristics IE indicated in 100 of FIG. 4A, and included in spatial relation information IE indicated in 110 of FIG. 4B, as indicated in 220 of FIG. 4D, or
Included in requested SRS transmission characteristics IE indicated in 100 of FIG. 4A, and included in spatial relation information per SRS resource IE indicated in 120 of FIG. 4B, as indicated in 320 of FIG. 4E.

The validity area may include cell information which the uplink SRS configuration transmitted by the user equipment can be determined to be valid and transmitted, may be indicated as in the following method, regardless of the level of configuring the validity area, and transferred and used. However, the methods described below are merely provided as one embodiment, and the validity area may be indicated according to other methods not described below.
1. Indicated by cell list:
Indicate validity area by list of cell IDs, as indicated in 410 of FIG. 4F.
2. Indicated by RAN area ID list:
Indicate validity area by list of RAN area IDs, as indicated in 420 of FIG. 4F.
3. Indicated by tracking area ID list (or registration area ID list):
Indicate validity area by list of tracking area IDs (or registration area IDs), as indicated in 430 of FIG. 4F.

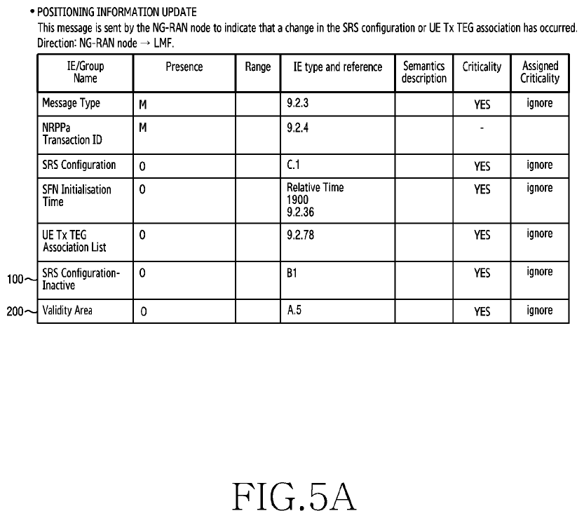

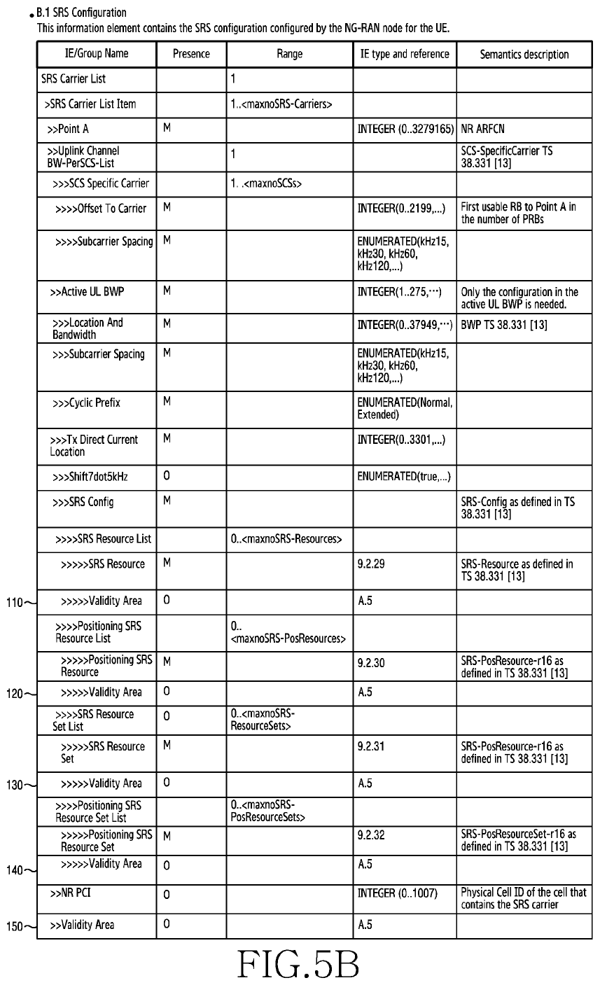

FIG. 5A illustrates a configuration of an IE included in an NRPPa positioning information update message and an NRPPa positioning information update message according to various embodiment of the disclosure, and FIG. 5B illustrates a configuration of an IE included in an NRPPa positioning information update message and an NRPPa positioning information update message according to various embodiment of the present disclosure.

Referring to FIGS. 5A and 5B, an embodiment of a configuration of each IE included in an NRPPa positioning information update message (for example, the message of operation 540 of FIG. 2) and an NRPPa positioning information update message transferred to an LMF through an AMF by a base station may be described. The term of the IE included in FIGS. 5A and 5B is merely provided as an example, and another name having the same function may be also used.

FIGS. 5A and 5B are examples of a configuration of an NRPPa positioning information update message, and the NRPPa positioning information update message may include uplink SRS configuration information used by the user equipment in the RRC inactive state as indicated in 100 of FIG. 5A, in addition to the existing SRS configuration IE. If the SRS configuration information to be used in the RRC inactive state is not distinguished and transferred, the base station may determine that the SRS configuration information included in the existing SRS configuration IE is used, regardless of the RRC state of the user equipment.

The NRPPa positioning information update message may include validity area IE information configured for the user equipment by the base station. Even though the LMF has included the validity area information in the NRPPa positioning information request message and transferred in the previous procedure, the LMF may determine that the validity area information transferred through the NRPPa positioning information request message has been transferred to the user equipment if the base station has not included the validity IE information in the NRPPa positioning information update message. If the validity area is included in the NRPPa positioning information update message, the base station may determine the validity area information configured for the user equipment according to the following level, and transfer the same to the LMF. However, the methods described below are merely provided as one embodiment, and the validity area may be configured according to other methods not described below and transferred.
1. User equipment level:
Included as indicated in 200 of FIG. 5A.
2. For each SRS resource:
Included as indicated in 110 of FIG. 5B.
3. For each positioning SRS resource:
Included as indicated in 120 of FIG. 5B.
4. For each SRS resource set:
Included as indicated in 130 of FIG. 5B.
5. For each positioning SRS resource set:
Included as indicated in 140 of FIG. 5B.
6. For each SRS carrier:
Included as indicated in 150 FIG. 5B.

The validity IE may be configured in the NRPPa positioning information update message, as shown in FIG. 4F.

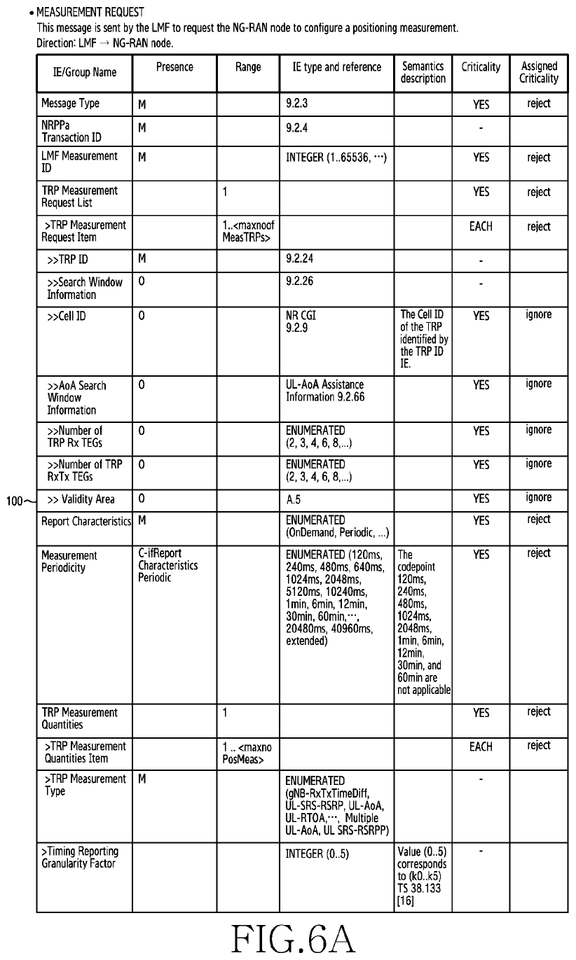

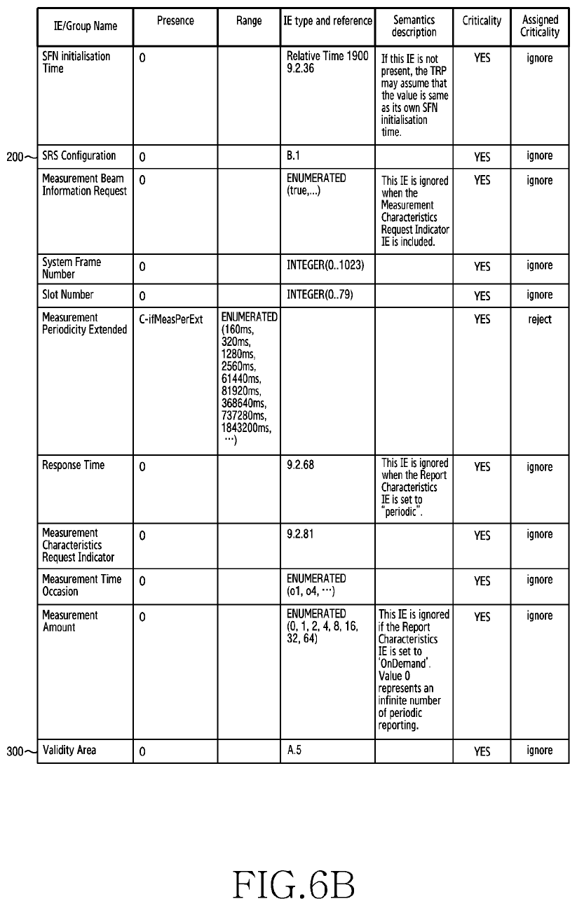

FIG. 6A illustrates a configuration of an IE included in an NRPPa measurement request message and an NRPPa measurement request message according to various embodiments of the present disclosure, and FIG. 6B illustrates a configuration of an IE included in an NRPPa measurement request message and an NRPPa measurement request message according to various embodiments of the disclosure.

Referring to FIGS. 6A and 6B, an embodiment of a configuration of each IE included in an NRPPa measurement request message (for example, the message of operation 620 of FIG. 2) and an NRPPa measurement request message transferred to a base station to an AMF by an LMF may be described. The term of the IE included in FIGS. 6A and 6B is merely provided as an example, and another name having the same function may be also used.

The NRPPa measurement request message may include validity area IE information required for uplink SRS measurement by each base station. When a validity area is included in the NRPPa measurement request message, the LMF may determine the validity area information configured for the user equipment according to the following level, and transfer the same to the base station. However, the methods described below are merely provided as one embodiment, and the LMF may configure the validity area according to other methods not described below and transfer the same.
1. User equipment level:
Included as indicated in 300 of FIG. 6B.
2. For each TRP ID:
Included as indicated in 100 of FIG. 6A.
3. For each SRS resource:
Included in SRS configuration IE indicated in 200 of FIG. 6B and included as indicated in 110 of FIG. 5B within SRS configuration IE.
4. For each positioning SRS resource:
Included in SRS configuration IE indicated in 200 of FIG. 6B and included as indicated in 120 of FIG. 5B in SRS configuration IE.
5. For each SRS resource set:
Included in SRS configuration IE indicated in 200 of FIG. 6B and included as indicated in 130 of FIG. 5B in SRS configuration IE.
6. For each positioning SRS resource set:
Included in SRS configuration IE indicated in 200 of FIG. 6B and included as indicated in 140 of FIG. 5B in SRS configuration IE.
7. For each SRS carrier:
Included in SRS configuration IE indicated in 200 of FIG. 6B and included as indicated in 150 of FIG. 5B in SRS configuration IE.

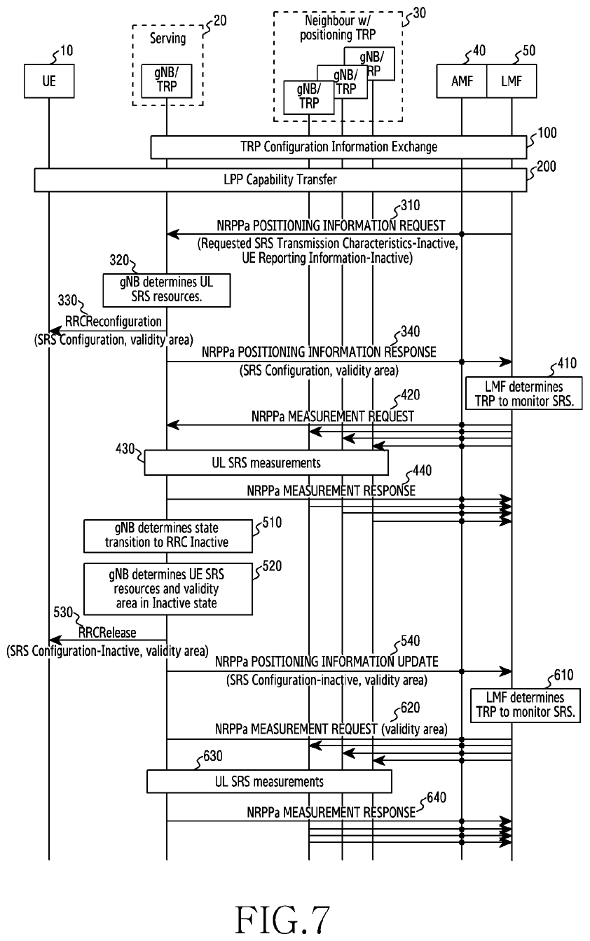

FIG. 7 illustrates a flow of a signal for providing a positioning service by using an uplink SRS transmitted by a user equipment in an RRC inactive state according to various embodiment of the present disclosure.

Referring to FIG. 7, when a positioning service is provides using an uplink SRS of a user equipment in an RRC inactive state, a method of determining by a serving base station a validity area in which uplink SRS configuration information received while the user equipment transitions to the RRC inactive state is continuously used even when a cell in which the terminal is located is changed as the user equipment moves, and transferring the same to the user equipment and the LMF and a signaling procedure may be described.

In operation 100, an LMF 50 may perform a procedure of receiving information on a TRP for a positioning service from base stations 20 and 30 (for example, an NR gNB or an LTE eNB), and messages required for a procedure of receiving information on a TRP for a positioning service may be transmitted and/or received through an AMF 40.

In operation 200, the LMF 50 may request positioning capability information of the user equipment 10 through an LPP capability transfer procedure with the user equipment 10, and may receive positioning capability information from the user equipment. When the LMF 50 determines to use the positioning service method using the uplink SRS in the user equipment 10 and starts a related procedure, the LMF 50 may transmit an NRPPa positioning information request message to a serving base station 20 of the user equipment through the AMF 40 in operation 310. The NRPPa positioning information request message may include, as information for requesting an uplink SRS configuration to be used by the user equipment, at least one of request SRS transmission characteristics information and UE reporting information. The NRPPa positioning information request message may further include, as information for requesting an uplink SRS configuration to be used by the user equipment in an RRC inactive state, at least one of requested SRS transmission characteristics-inactive information and UE reporting information-inactive information, and if there is no additional information related to the RRC inactive state, the serving base station 20 may perform SRS configuration with reference to at least one of requested SRS transmission characteristics information and UE reporting information, without distinguishing between an RRC-connected state and the RRC inactive state. For example, the configuration of the message used in operation 310 of FIG. 7 may be configure with reference to FIGS. 4A to 4F.

In operation 310, the serving base station 20 having received the NRPPa positioning information request message from the LMF 50 may determine, based on information included in the NRPPa positioning information request message, a resource to be used for uplink SRS (UL-SRS) transmission by the user equipment 10 in operation 320, and transfer an RRC message including information related to the uplink SRS transmission to the user equipment 10 in operation 330. In addition, the serving base station 20 may transfer, to the LMF 50 through the AMF 40, an NRPPa positioning information response message including the uplink SRS configuration information transferred to the user equipment, in operation 340.

When receiving the NRPPa positioning information response message from the serving base station 20, the LMF 50 may determine at least one 20 or 30 of a base station, a cell, or a TRP for monitoring the uplink SRS transmitted by the user equipment in operation 410, and may request uplink SRS monitoring of the user equipment by transmitting an NRPPa measurement request message to each base station through the AMF 40 as in operation 420. If, although not shown in FIG. 7, the uplink SRS transmission is not configured as persistent transmission and is configured as semi-persistent SRS transmission or aperiodic SRS transmission, the LMF 50 may need a procedure of transmitting an NRPPa positioning activation request message to the base station 20 and requesting activation of the SRS transmission of the user equipment. The base stations 20 and 30 may monitor the uplink SRS according to the information included in the NRPPa measurement request message received in operation 420, and then transfer a result of the monitoring to the LMF 50 through the AMF 40 by using an NRPPa measurement response message as in operation 440. Information included in the NRPPa measurement response message may be used to calculate location information of the user equipment by the LMF 50.

As in operation 510, if the serving base station 20 determines to cause the corresponding user equipment 10 to transition to the RRC inactive state, the serving base station 20 may determine, in operation 520, a resource to be used for uplink SRS (UL-SRS) transmission in the RRC inactive state by the user equipment 10 by using at least one of requested SRS transmission characteristics information and UE reporting information required for the positioning service in the RRC inactive state by the user equipment. In addition, the serving base station 20 may determine a validity area related to the uplink SRS transmission.

In operation 530, the serving base station 20 may transfer an RRC message including the information related to the uplink SRS transmission to the user equipment 10. In this case, the serving base station 20 may also transfer validity area information to the user equipment. When the user equipment 10 moves to a cell (or base station) within the validity area in the RRC inactive state, the user equipment 10 may determine that the uplink SRS configuration information received in operation 530 is continuously valid and perform uplink SRS transmission.

In operation 540, the serving base station 20 may transfer an NRPPa positioning information update message to the LMF 50 through the AMF 40 by including uplink SRS configuration information transferred to the user equipment and validity area information configured for the user equipment. The uplink SRS configuration information included in the message in operation 540 may be transferred by including a distinguisher corresponding to SRS configuration information used by the user equipment in the RRC inactive state, or including the SRS configuration information by using a name different from the existing uplink SRS configuration information. An embodiment of the configuration of the message used in operation 540 of FIG. 7 may be configured with reference to FIGS. 5A and 5B.

In the above-described embodiment (for example, operations 100 to 540 of FIG. 7), it is described that a procedure in which the serving base station 20 may determine a validity area in operation 520 and the serving base station 20 transfers the NRPPa positioning information update message to the LMF 50 through the AMF 40 by including validity area information in operation 540, as a basic procedure, but the serving base station 20 may include the validity area information in the NRPPa positioning information response message and transmit the same to the LMF 50 through the AMF 40 in operation 340 of FIG. 7. If the serving base station 20 includes the validity area information in the NRPPa positioning information response message and transmits the same to the LMF 50 through the AMF 40, the serving base station 20 may determine the validity area information before operation 340, and may also transfer the validity area information to the user equipment in advance in operation 330. In addition, when the serving base station 20 has transferred the validity area information to the user equipment 10 and the LMF 50 in operations 330 and 340, the validity area information may be omitted from an RRCRelease message transmitted to the user equipment 10 by the serving base station 20 in operation 530 and an NRPPa positioning information update message transferred to the LMF 50 in operation 540 may be transferred without omitting the validity area information. IF the NRPPa positioning information response message includes the validity area in operation 340, the serving base station 20 may include validity area IE information and configure an NRPPa positioning information update message in a method identical or similar to that of adding the validity area to the NRPPa positioning information update message included in FIGS. 5A and 5B.

When receiving the NRPPA positioning information update message from the serving base station 20, the LMF 50 may determine, in operation 610, a base station (or TRP) 20 or 30 for monitoring the uplink SRS transmitted by the user equipment, and may request uplink SRS monitoring of the user equipment by transmitting the NRPPa measurement request message to each base station through the AMF 40 as in operation 620. In this case, the validity area information may be included in the NRPPa measurement request message to assist uplink SRS reception transmitted by the user equipment in each base station. The base stations 20 and 30 may monitor the uplink SRS according to information included in the NRPPa measurement request message received in operation 620, and then transfer a result of the monitoring to the LMF 50 through AMF 40 by using the NRPPa measurement response message as in operation 640. Information included in the NRPPa measurement response message may be used to calculate location information of the user equipment by the LMF 50. An embodiment of the configuration of the message used in operation 620 of FIG. 7 may be configured with reference to FIGS. 6A and 6B.

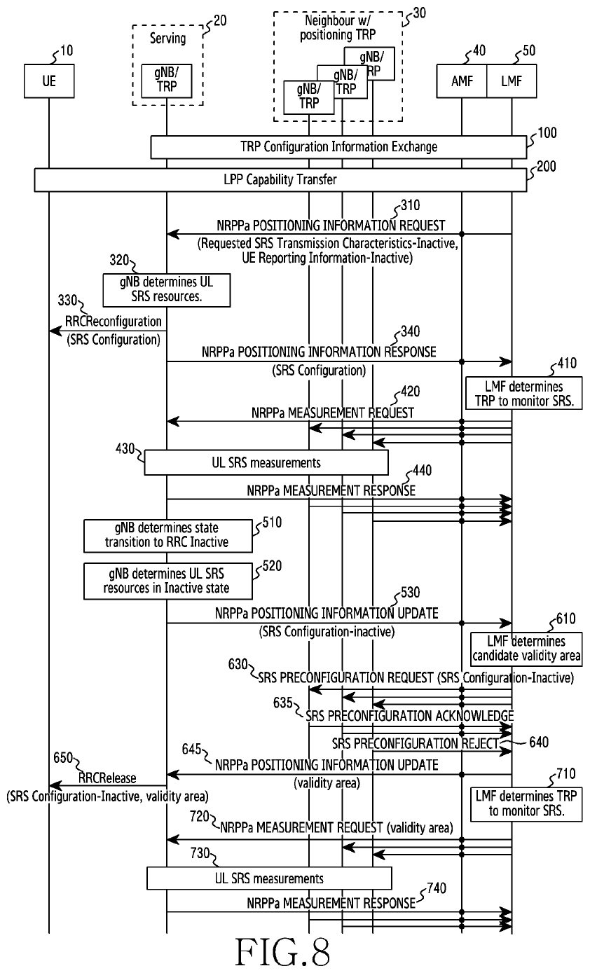

FIG. 8 illustrates a flow of a signal for providing a positioning service by using an uplink SRS transmitted by a user equipment in an RRC inactive state according to various embodiments of the present disclosure.

Referring to FIG. 8, when a positioning service is provided using an uplink SRS transmitted by a terminal in an RRC inactive state, in determining a validity area in which uplink SRS configuration information received while the user equipment transitions to the RRC inactive state can be continuously used even when a cell in which the user equipment is located is changed as the user equipment moves, the SRS signal transmitted by the user equipment may be an interference signal when base stations receive an uplink signal of another terminal, and thus a method of determining a candidate base station and/or cells in which an LMF can be the validity area, transferring uplink SRS configuration information received from a serving base station to the corresponding base stations, and then receiving a response of whether the information can be used, to determine the validity area, and a signaling procedure may be described. The LMF may determine a candidate base station and/or cells of the validity area, based on at least one of the location of the user equipment, serving base station/cell information, requested SRS transmission characteristics to be used by the user equipment in the RRC inactive state, or uplink SRS configuration information. The LMF may finally determine the validity area after transferring the uplink SRS configuration information to the candidate base stations of the validity area and responding with whether the information can be used. The LMF may transfer validity area information when the serving base station transfers the uplink SRS configuration to the user equipment after the LMF transfers the validity area information to the serving base station.

Operations 100 to 440 may follow operations 100 to 440 of FIG. 7.

As in operation 510, when the serving base station 20 determines to cause the corresponding terminal 10 to transition to the RRC inactive state, the serving base station 20 may determine a resource to be used to transmit uplink SRS (UL-SRS) transmission by the user equipment 10 in the RRC inactive state by using at least one of requested SRS transmission characteristics information and UE reporting information required for a positioning service by the user equipment in the RRC inactive state from the LMF 50 in operation 520.

In operation 530, the serving baes station 20 may include the uplink SRS configuration information transferred to the user equipment in an NRPPa positioning information update message and transfer the same to the LMF 50 through the AMF 40. The uplink SRS configuration information included in the NRPPa positioning information update message in operation 530 may include a distinguisher corresponding to SRS configuration information used by the user equipment in the RRC inactive state, or include the SRS configuration information by using a name different from the existing uplink SRS configuration information. An embodiment of the configuration of the message used in operation 540 of FIG. 8 may be configured with reference to FIGS. 5A and 5B.

When the LMF 50 receives the NRPPa positioning information update message from the serving base station 20, the LMF 50 may determine a candidate validity area related to the uplink SRS transmission in operation 610. The LMF 50 may transmit an NRPPa SRS pre-configuration request message to each base station included in the candidate validity area through the AMF 40 as in operation 620. The LMF 50 may transfer the uplink SRS configuration information received from the serving base station 20 to the base stations and then enquire about whether the information can be used, and may receive, from the base stations, an NRPPa SRS pre-configuration response message indicating that the information can be used as in operation 630 or an NRPPa SRS pre-configuration reject message indicating that the information cannot be used in the corresponding base stations as in operation 635. The LMF 50 may determine a validity area, based on the message received from the base stations in operations 630 and 635, and may transmit an NRPPa positioning information update message as in operation 640 to transfer the determined validity area information to the serving base station. In operation 640, the LMF 50 may allow to transfer the NRPPa positioning information update message to the serving base station 20, or may define a new NRPPa message and use the same when transferring the validity area information.

In the above-described embodiment (for example, operations 100 to 640 of FIG. 8), it is described that a procedure in which the LMF 50 determines a candidate validity area in operation 610 and the LMF 50 transfers the NRPPa SRS pre-configuration request message to the serving base station 20 through the AMF 40 by including the uplink SRS configuration information in operation 620, and then transfers, based on a response message, the determined validity area information to the serving base station 20 in operation 640, as a basic procedure, but after operation 340 of FIG. 8, the LMF 50 may determine the candidate validity area, and the LMF 50 may perform, after operation 340, a procedure from operations 610 to 640 in which the LMF 50 transfers the NRPPa SRS pre-configuration request message to the serving base station 20 through the AMF 40 by including the uplink SRS configuration information.

The serving base station 20 having received the NRPPa positioning information update message including the validity area information from the LMF 50 through the AMF 40 in operation 640 may transfer an RRC message including information related to uplink SRS transmission to the user equipment 10 in operation 650. In this case, the serving base station 20 may transfer the validity area information to the user equipment. When the user equipment 10 moves to at least one of a cell and a base station within the validity area in the RRC inactive state, the user equipment may determine that the uplink SRS transmission configuration information received in operation 650 is continuously valid, and perform the uplink SRS transmission.

The LMF determines a base station/cell/TRP 20 or 30 for monitoring an uplink SRS transmitted by the user equipment in operation 710, and requests uplink SRS monitoring of the user equipment by transmitting an NRPPa measurement request message to each base station through the AMF 40 as in operation 720. If the uplink SRS transmission is not configured as persistent transmission and is configured as semi-persistent SRS transmission or aperiodic SRS transmission, a procedure in which the LMF 50 transmits an NRPPa positioning activation request message to the serving base station 20 and requests activation of SRS transmission of the user equipment may be required, but in this embodiment, the procedure may be omitted. The base stations 20 and 30 may monitor the uplink SRS according to information included in the NRPPa measurement request message received in operation 720, and then transfers a result of the monitoring to the LMF 50 through the AMF 40 by using an NRPPa measurement response message as in operation 740. Information included in the NRPPa measurement response message may be used to calculate location information of the user equipment by the LMF 50.

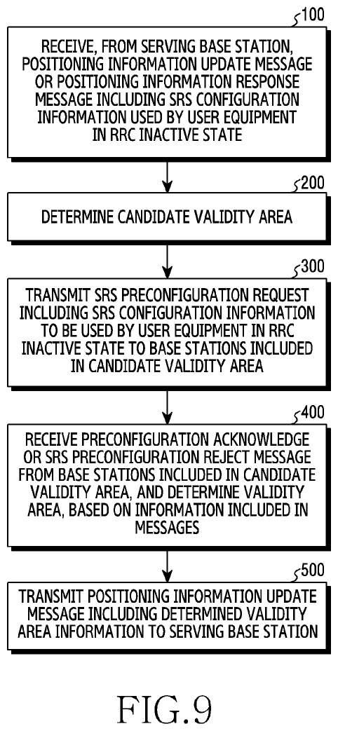

FIG. 9 illustrates an operation order of an LMF according to various embodiments of the present disclosure.

Referring to FIG. 9, an operation order of an LMF (for example, the LMF 50) according to the above-described embodiment of FIG. 8 may be described. In operation 100, the LMF may receive, from a serving base station, an NRPPa positioning information response message or an NRPPa positioning information update message including uplink SRS configuration information used by the user equipment in an RRC inactive state.

In operation 200, the LMF may determine, based on the location of the user equipment (for example, serving base station (or cell) information, requested SRS transmission characteristics to be used by the user equipment in the RRC inactive state, or uplink SRS configuration information), a candidate base station and/or cells for a validity area.

In operation 300, the LMF may transmit, to base stations included in the candidate validity area, an NRPPa SRS pre-configuration request message including uplink SRS configuration information to be used by the user equipment in the RRC inactive state.

In operation 400, the LMF may receive at least one of an NRPPa SRS pre-configuration acknowledge and an NRPPa SRS pre-configuration reject message from base stations included in the candidate validity area, and determine a validity area, based on information included in the received messages.

In operation 500, the LMF may transmit a positioning information update message including the determined validity area information to the serving base station.

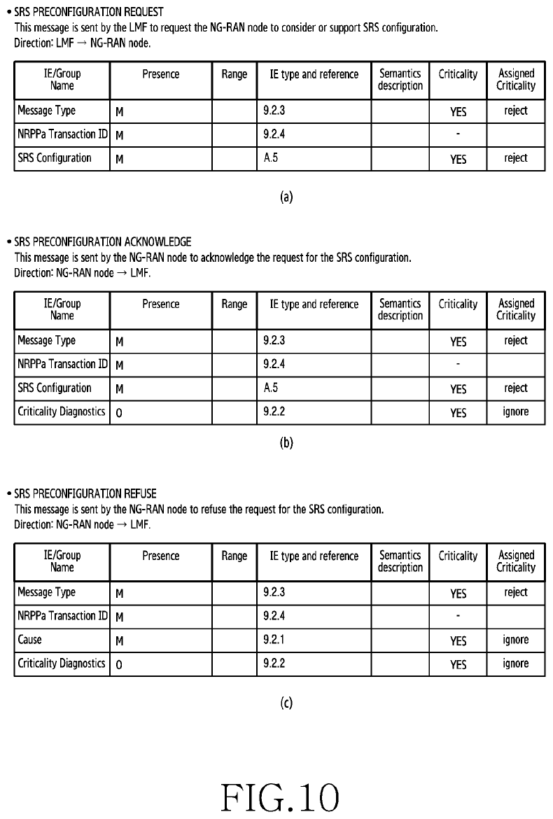

FIG. 10 illustrates a configuration of a message related to an NRPPa SRS pre-configuration request procedure and an IE included in the message related to the NRPPa SRS pre-configuration request procedure according to various embodiments of the present disclosure.

Referring to FIG. 10, an embodiment of a configuration of a message related to an NRPPa SRS pre-configuration request procedure (for example, the message of operations 620, 630, and 635 of FIG. 8) transferred to a base station through an AMF by an LMF and each IE included in the message related to the NRPPa SRS pre-configuration request procedure. The term of the message and the term of the IE included in FIG. 10 are provided as an example, and another name having the same function may be used.

Part (a) of FIG. 10 may be an embodiment of a configuration of an NRPPa SRS pre-configuration request message. The NRPPa SRS pre-configuration request message may include a message type IE used to distinguish between the existing NRPPa message and the same and similar NRPPa message, and an NRPPa transaction ID IE used for distinguishing between NRPPa procedures. In addition, SRS configuration IE information may be included so that the LMF enquires after base stations whether the uplink SRS configuration information received from a serving base station is available. An example of a configuration of the SRS configuration IE may follow the example of the configuration of the message included in FIG. 5B, but the validity area IE included in FIG. 5B may not be included.

Part (b) of FIG. 10 illustrates an example of a configuration of an NRPPa SRS pre-configuration response message. The NRPPa SRS pre-configuration response message may include a message type IE used to distinguish between the existing NRPPa message and the same or similar NRPPa message, an NRPPa transaction ID used to distinguish between NRPPa procedures, and a criticality diagnostics IE for criticality processing during the NRPPa SRS pre-configuration request procedure. In addition, the NRPPa SRS pre-configuration response message may also include uplink SRS configuration information available for base stations. An example of a configuration of the SRS configuration IE may follow the example of the configuration of the message included in FIG. 5B, but the validity area IE included in FIG. 5B may not be included.

Part (c) of FIG. 10 illustrates an example of a configuration of an NRPPa SRS pre-configuration reject message. The NRPPa SRS pre-configuration reject message may include a message type IE used to distinguish between the existing NRPPa message and a similar NRPPa message, an NRPPa transaction ID IE used to distinguish between NRPPa procedures, and a criticality diagnostics IE for criticality processing during the NRPPa SRS pre-configuration request procedure. In addition, the NRPPa SRS pre-configuration reject message may also include a cause IE including a reason that uplink SRS configuration is not available for a base station.

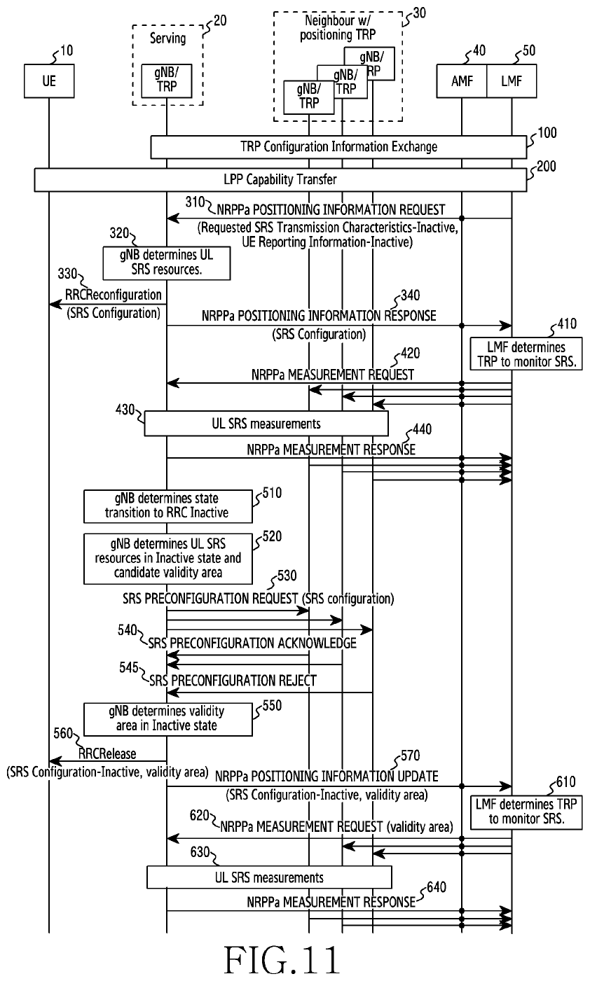

FIG. 11 illustrates a flow of a signal for providing a positioning service by using an uplink SRS transmitted by a user equipment in an RRC inactive state according to various embodiments of the present disclosure.

Referring to FIG. 11, when a positioning service is provided using an uplink SRS transmitted by a user equipment in an RRC inactive state, in determining a validity area in which uplink SRS configuration information received while the user equipment transitions to the RRC inactive state can be continuously used even when a cell in which the user equipment is located is changed as the user equipment moves, the SRS signal transmitted by the user equipment may be an interference signal when base stations receive an uplink signal of another terminal, and thus a method of determining a candidate base station and/or cells in which an LMF can be the validity area, transferring uplink SRS configuration information received from a serving base station to the corresponding base stations, and then receiving a response of whether the information can be used, to determine the validity area, and a signaling procedure may be described.

The serving base station 20 may determine, based on the location of the user equipment (for example, serving base station (or cell) information, requested SRS transmission characteristics to be used by the user equipment in the RRC inactive state, or uplink SRS configuration information), a candidate base station and/or cells for a validity area. The serving base station 20 may finally determine the validity area after transferring the uplink SRS configuration information to the candidate base stations of the validity area and responding with whether the information can be used. The serving base station 20 may transfer validity area information when transferring the uplink SRS configuration to the user equipment 10 and LMF 50.

Operations 100 to 440 may follow the procedure of operations 100 to 440 of FIG. 7.

As in operation 510, when the serving station 20 determines to cause the corresponding user equipment 10 to transition to the RRC inactive state, the serving base station 20 may determine, in operation 520, a candidate validity area and a resource to be used for uplink SRS (UL-SRS) transmission by the user equipment 10 in the RRC inactive state, by using at least one of requested SRS transmission characteristics information and UE reporting information required for a positioning service in the RRC inactive, received from the LMF 50.

In operation 530, the serving base station 20 may transmit an Xn SRS pre-configuration request message to each base station included in a candidate validity are as in operation 530, and may transfer uplink SRS configuration information to base stations and then enquire about whether the information can be used.

The serving base station 20 may receive, from each of the base stations, an Xn SRS pre-configuration response message indicating that the uplink SRS configuration information can be used as in operation 540. Alternatively, the serving base station 20 may receive, from each of the base stations, an Xn SRS pre-configuration reject message indicating that the information is not available for the corresponding base stations as in operation 545. The serving base station 20 may determine a validity area, based on messages received from the base stations in operations and 540 and 545, and may transfer an RRC message including the uplink SRS transmission configuration information and validity area information to the user equipment 10 in operation 560.

The serving base station 20 may transmit an NRPPa positioning information update message including the uplink SRS transmission configuration information and the validity area information to the LMF 50 through the AMF 40 as in operation 570. The LMF 50 having received the NRPPa positioning information update message may determine, in operation 610, at least one 20 or 30 of a base station, a cell, or a TRP for monitoring an uplink SRS transmitted by the user equipment, and may request uplink SRS monitoring of the user equipment by transmitting an NRPPa measurement request message to each base station through the AMF 40 as in operation 620. However, although not shown in FIG. 11, if the uplink SRS transmission is not configured as persistent transmission and is configured as semi-persistent SRS transmission or aperiodic SRS transmission, the LMF 50 may need a procedure of transmitting an NRPPa positioning activation request message to the serving base station 20 and requesting activation of SRS transmission of the user equipment. The base stations 20 and 30 may monitor an uplink SRS according to information included in the NRPPa measurement request message received in operation 620, and then transfer a result of the monitoring to the LMF 50 through the AMF 40 by using an NRPPa measurement response message as in operation 540. Information included in the NRPPa measurement response may be used to calculate location of the user equipment by the LMF 50.

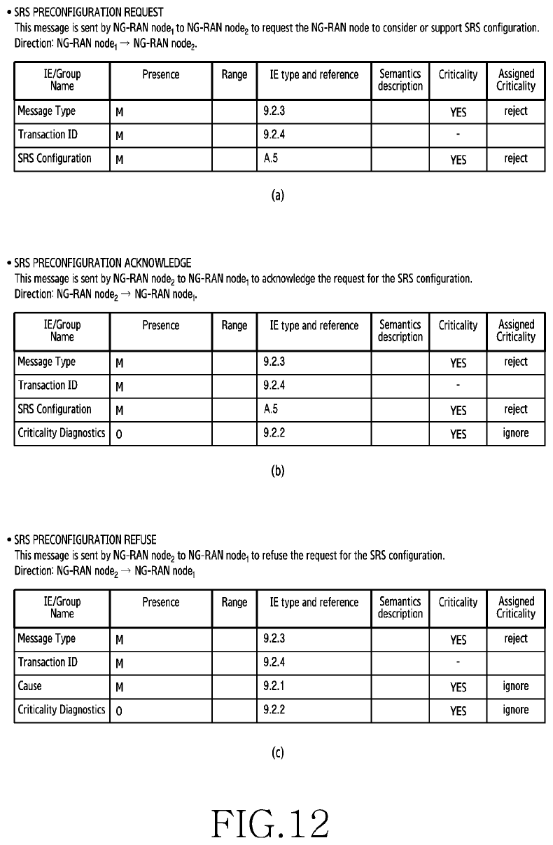

FIG. 12 illustrates a configuration of a message related to an Xn SRS pre-configuration request procedure and an IE included in the message related to the Xn SRS pre-configuration request procedure according to various embodiments of the present disclosure.

Referring to FIG. 12, an embodiment of a configuration of a message related to an Xn SRS pre-configuration request procedure (for example, the message of operations 530, 540, and 545 of FIG. 11) transferred to another base station by a serving base station 20 and each IE included in the message related to the Xn SRS pre-configuration request procedure. The term of the message and the term of the IE included in FIG. 12 are provided as an example, and another name having the same function may be used.

Part (a) of FIG. 12 illustrates an example of a configuration of an Xn SRS pre-configuration request message. The Xn SRS pre-configuration request message may include a message type IE used to distinguish between Xn messages, and a transaction ID IE used to distinguish between positioning-related procedures in an Xn procedure. In addition, the Xn SRS pre-configuration request message may include SRS configuration IE information to allow the serving base station to enquire after other base stations whether the uplink SRS configuration information is available. An example of a configuration of the SRS configuration IE may follow the example of the configuration of the message included in FIG. 5B, but the validity area IE included in FIG. 5B may not be included.

Part (b) of FIG. 12 illustrates an example of a configuration of an Xn SRS pre-configuration response message. The Xn SRS pre-configuration response message may include a message type IE used to distinguish between Xn messages, a transaction ID used to distinguish between positioning-related procedures in an Xn procedure, and a criticality diagnostics IE for criticality processing during the SRS pre-configuration request procedure. In addition, the Xn SRS pre-configuration response message may also include uplink SRS configuration information available for base stations. An example of a configuration of the SRS configuration IE may follow the example of the configuration of the message included in FIG. 5B, but the validity area IE included in FIG. 5B may not be included.

Part (c) of FIG. 12 illustrates an example of a configuration of an Xn SRS pre-configuration reject message. The Xn SRS pre-configuration reject message may include a message type IE used to distinguish between Xn messages, a transaction ID IE used to distinguish between positioning-related procedures in an Xn procedure, and a criticality diagnostics IE for criticality processing during the Xn SRS pre-configuration request procedure, and may also include a cause IE including a reason that uplink SRS configuration is not available for a base station.

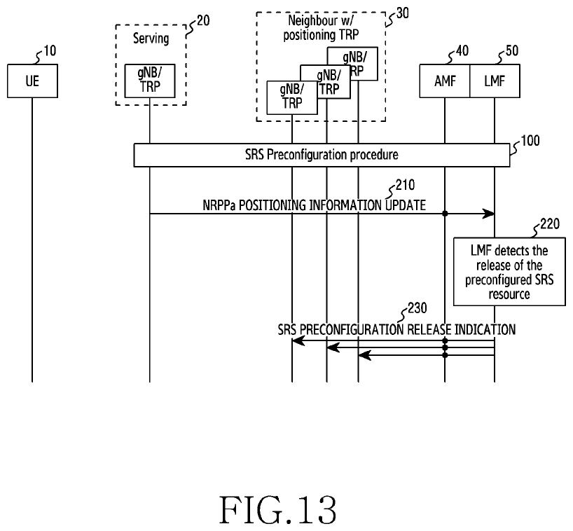

FIG. 13 illustrates a flow of a signal in a case where a serving base station has released an uplink SRS configuration of a user equipment according to various embodiments of the present disclosure.

Referring to FIG. 13, a procedure in which an LMF 50 notifies to base stations included in a validity area that use of the uplink SRS configuration has been released when a serving base station 20 has released an uplink SRS configuration of a user equipment 10 may be described. Specifically, a procedure in which the serving base station 20 notifies to the LMF 50 that the uplink SRS configuration has been released and the LMF 50 then notifies to the base stations included in the validity area that use of the uplink SRS configuration has been released may be described.

In operation 100, uplink SRS configuration information for the user equipment 10 may be transferred to the user equipment 10 and the base stations 30 in the validity area. In operation 100, the uplink SRS configuration information for the user equipment 10 may be already used, or may not be used.

When the serving base station 20 releases the uplink SRS configuration for the user equipment 10, the serving base station 20 may transmit an NRPPa positioning information update message to the LMF 50 through the AMF 40 to notify releasing and changing of the uplink SRS configuration of the user equipment 10 as in operation 210. Although not explicitly shown in FIG. 13, if necessary, the serving base station 20 may indicate the releasing and the changing of the uplink SRS configuration by using an RRCReconfiguration message or an RRCRelease message.

In operation 220, the serving base station 20 may identify, based on information included in the NRPPa positioning information update message, that the uplink SRS configuration of the user equipment 10 has been released.

As in operation 230, the LMF 50 may transmit, to the base stations 30 having enquired about whether the uplink SRS configuration of the user equipment 10 or the base station 30 can be used in the validity area, an NRPPa SRS pre-configuration release indication message to notify that the uplink SRS configuration of the user equipment 10 has been released.

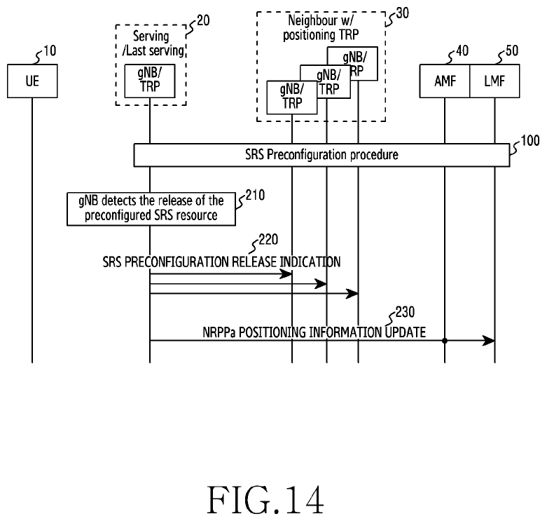

FIG. 14 illustrates a flow of a signal in a case where a serving base station has released an uplink SRS configuration of a user equipment according to various embodiments of the present disclosure.

Referring to FIG. 14, a procedure of notifying to base stations included in a validity area that use of the uplink SRS configuration has been released when a serving base station 20 has released an uplink SRS configuration of a user equipment may be described. Specifically, a procedure in which the serving base station 20 notifies to the base stations included in the validity area that use of the uplink SRS configuration has been released may be included.

In operation 100, uplink SRS configuration information for the user equipment 10 may be transferred to the user equipment 10 and the base stations 30 in the validity area. In operation 100, the uplink SRS configuration information for the user equipment 10 may be already used, or may not be used.

As in operation 210, the serving base station 20 may release the uplink SRS configuration for the user equipment 10.

As in operation 220, the serving base station 20 may transmit, to the base stations 30 having enquired about whether the uplink SRS configuration of the user equipment 10 or the base station 30 can be used in the validity area, an Xn SRS pre-configuration release indication message to notify that the uplink SRS configuration of the user equipment 10 has been released.

As in operation 230, the serving base station 20 may transmit the NRPPa positioning information update message to the LMF 50 through the AMF 40 to notify of releasing and changing of the uplink SRS configuration of the user equipment 10. Although not explicitly shown in FIG. 14, if necessary, the serving base station 20 may indicate the releasing and the changing of the uplink SRS configuration by using an RRCReconfiguration message or an RRCRelease message.

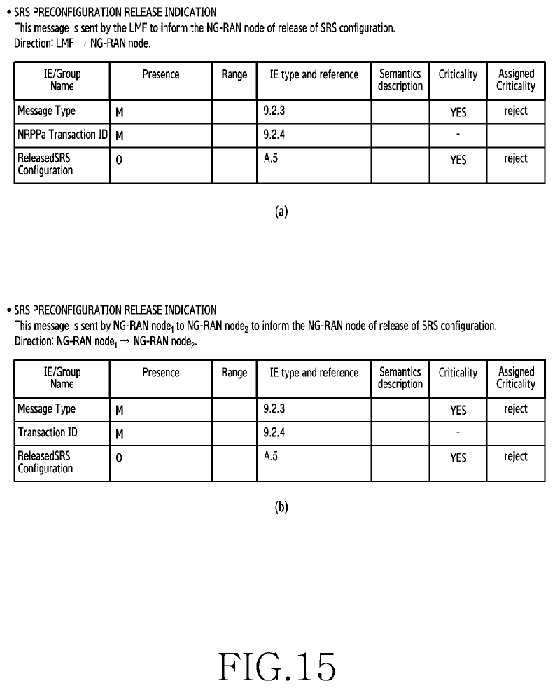

FIG. 15 illustrates a configuration of an NRPPa SRS pre-configuration release request message according to various embodiments of the present disclosure.

Referring to FIG. 15, an embodiment of a configuration of an NRPPa SRS pre-configuration release request message (for example, the message of operation 230 of FIG. 13) and an Xn SRS pre-configuration release request message (for example, the message of operation 220 of FIG. 14) transferred to a base station through the AMF 40 by the LMF 50 may be described. The term of the message and the term of the IE included in FIG. 15 are merely provided as an example, and another name having the same function may be also used.

Part (a) of FIG. 15 illustrates an example of a configuration of an NRPPa SRS pre-configuration release request message. The NRPPa SRS pre-configuration release request message may include a message type IE used to distinguish between the existing NRPPa message and a similar NRPPa message, and an NRPPa transaction ID IE used to distinguish between NRPPa procedures. In addition, the NRPPa SRS pre-configuration release request message may also include released SRS configuration IE information for notifying uplink SRS configuration information to be released. An example of a configuration of the released SRS configuration IE may follow the example of the configuration of the message included in FIG. 5B, but the validity area IE included in FIG. 5B may not be included. In addition, when the released SRS configuration IE is not included, information related to all uplink SRS configurations requested from the corresponding serving base station may be released.

Part (b) of FIG. 15 illustrates an example of a configuration of an Xn SRS pre-configuration release request message. The Xn SRS pre-configuration release request message may include a message type IE used to distinguish between Xn messages and a transaction ID IE used to distinguish between positioning-related procedures within an Xn procedure. In addition, the Xn SRS pre-configuration release request message may also include released SRS configuration IE information for notifying the uplink SRS configuration information to be released. An example of a configuration of the released SRS configuration IE may follow the example of the configuration of the message included in FIG. 5B, but the validity area IE included in FIG. 5B may not be included. In addition, when the released SRS configuration IE is not included, information related to all uplink SRS configurations requested from the corresponding serving base station may be released

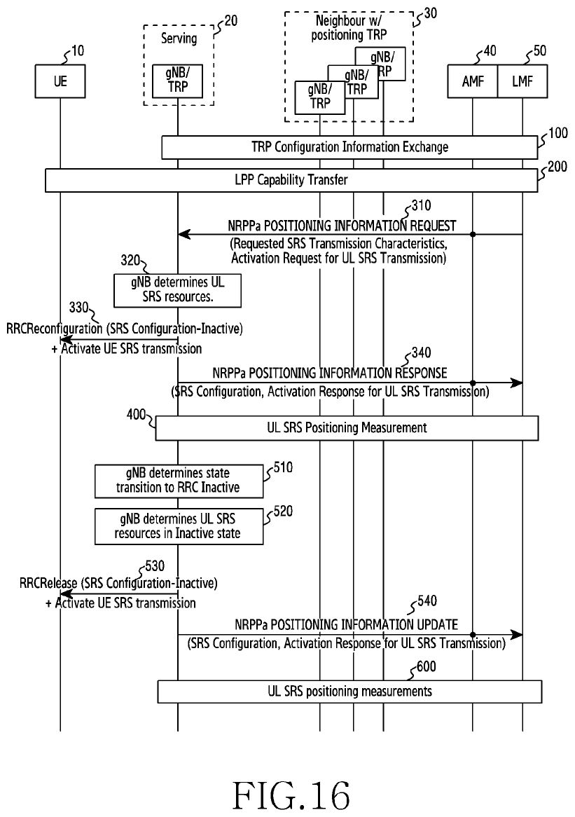

FIG. 16 illustrates an improved signal flow in a positioning activation procedure according to various embodiments of the present disclosure.

Referring to FIG. 16, a method for improving an inefficient signal procedure in relation to a positioning activation procedure in an RRC inactivate state of a user equipment may be described. In the existing method, when the user equipment maintains a serving cell in the RRC inactive state and positioning is started based on an uplink SRS of the user equipment, a serving base station may need to wait for a predetermined time until an NRPPa positioning activation request message is received from the LMF before an RRCRelease message including SRS configuration information is transmitted to the user equipment. In an embodiment of FIG. 16, a method of simplifying a positioning activation procedure by a user equipment in an RRC inactive state by adding information related to positioning activation or deactivation during an NRPPa positioning information procedure may be described.

In operation 100, the LMF 50 may perform a procedure of receiving information on a TRP for a positioning service from base stations 20 and 30 (for example, NR gNB or LTE eNB), and messages required for the procedure of receiving the information on the TRP for the positioning service may be transmitted and/or received through the AMF 40.

In operation 200, the LMF 50 may request positioning capability information of the user equipment 10 through an LPP capability transfer procedure with the user equipment 10, and may receive the positioning capability information from the user equipment 10.

When the LMF 50 determines to use a positioning service method using an uplink SRS in the user equipment 10 and starts a related procedure, the LMF 50 may transmit an NRPPa positioning information request message to the serving base station 20 of the user equipment through the AMF 40 in operation 310. The NRPPa positioning information request message may include, as information for requesting an uplink SRS configuration to be used by the user equipment, at least one of requested SRS transmission characteristics information and UE reporting information. The requested SRS transmission characteristics information may include information for requesting the uplink SRS configuration for semi-persistent or aperiodic use.

In addition, when the LMF 50 determines to request activation based on the information for requesting the uplink SRS configuration for the semi-persistent or aperiodic use, the LMF 50 may include activation request for UL SRS transmission information in the NRPPa positioning information request message. In the existing operation, the LMF 50 is allowed to request, based on uplink SRS configuration information allocated by the serving base station 20, the uplink SRS configuration requiring activation from the serving base station 20, but for efficiency of the positioning activation procedure, the LMF 50 may transmit the message by including positioning activation-related information for requesting the uplink SRS configuration operation, in association with the requested SRS transmission characteristics information for requesting the uplink SRS configuration.

In operation 320, the serving base station 20 having received the NRPPa positioning information request message from the LMF 50 may determine a resource to be used for uplink SRS (UL-SRS) transmission by the user equipment 10, based on information included in the NRPPa positioning information request message.

In operation 330, the serving base station 20 may transfer an RRC message (for example, an RRCReconfiguration message) including the information related to the uplink SRS transmission to the user equipment 10.

In operation 330, the serving base station 20 may transmit activate UE SRS transmission information to the user equipment 10 by using a media access control (MAC) control element (CE) for uplink SRS configuration requiring activation, based on the positioning activation information received in operation 310 among the uplink SRS configuration information configured for semi-persistent or aperiodic use.

In operation 340, the serving base station 20 may transfer, to the LMF 50 through the AMF 40, an NRPPa positioning information response message including information on a result of the activation and uplink SRS configuration information transferred to the user equipment 10.

In operation 400, the LMF 50 may determine at least one 20 or 30 of a base station, a cell, or a TRP for monitoring an uplink SRS transmitted by the user equipment 10. The LMF 50 may request uplink SRS monitoring by using an NRPPa measurement request procedure from each base station through the AMF 40. The LMF 50 may receive a result of measurement of the uplink SRS from the serving base station 20, and may calculate location information of the user equipment, based on the received information.

As in operation 510, when the serving base station 20 determines to cause the user equipment 10 to transition to an RRC inactive state, the serving base station 20 may determine, in operation 520, a resource to be used for uplink SRS (UL-SRS) transmission in the RRC inactive state by the user equipment 10 by using at least one of requested SRS transmission characteristics information and UE reporting information required for a positioning service in the RRC inactive state, received from the LMF 50.

In operation 530, the serving base station 20 may transfer an RRC message (for example, RRCRelease message) including information related to uplink SRS transmission to the user equipment 10. In this case, the serving base station 20 may transmit activate UE SRS transmission information to the user equipment 10 by using a MAC CE for the uplink SRS configuration requiring activation, based on the positioning activation information received in operation 310.

In operation 540, the serving base station 20 may transfer, to the LMF 50 through the AMF 40, an NRPPa positioning information update message including information on a result of the activation and uplink SRS configuration information transferred to the user equipment.

In operation 600, the LMF 50 may determine at least one 20 or 30 of a base station, a cell, or a TRP for monitoring an uplink SRS transmitted by the user equipment 10. The LMF 50 may request uplink SRS monitoring of the user equipment 10 from each base station through the AMF 40 by using an NRPPa measurement request procedure. The LMF 50 receives a result of measurement of an uplink SRS from the serving base station 20, and the LMF 50 calculates location information of the user equipment, etc., based on the received information.

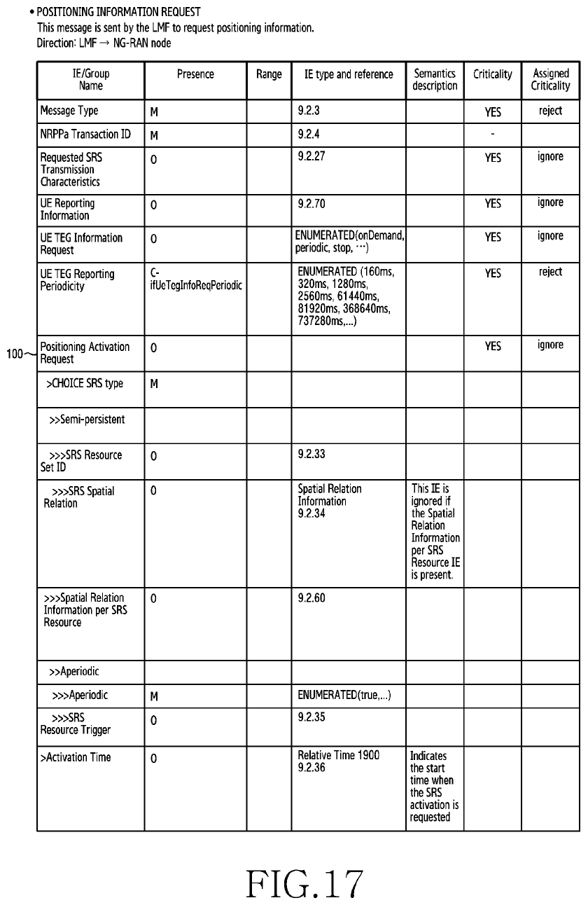

FIG. 17 illustrates a configuration of an NRPPa positioning information request message according to various embodiments of the present disclosure.

Referring to FIG. 17, FIG. 17 illustrates an example of a configuration of an NRPPa positioning information request message (for example, the message of operation 310 of FIG. 16) transferred to a bas base station through an AMF by an LMF. The name of the IE included in FIG. 17 is merely provided as an example, and another name having the same function may be also used. The NRPPa positioning information request message may include, in addition to information included in the existing NRPPa positioning information request message, a positioning activation request IE related to a positioning activation request as indicated in 100. The positioning activation request IE may include at least one of activation request information related to semi-persistent uplink SRS transmission and activation request information related to aperiodic uplink SRS transmission. The information related to each activation request is identical or similar to IE information included in the existing NRPPa positioning activation request message, and thus the activation request-related information may include at least one of SRS resource set ID and SRS spatial relation and spatial relation information per SRS resource-related IE information in a case of semi-persistent. Alternatively, the activation request-related information may include at least one of aperiodic operation indicator and SRS resource trigger IE information in a case of aperiodic. In addition, the activation request-related information may also include the existing activation time IE information.

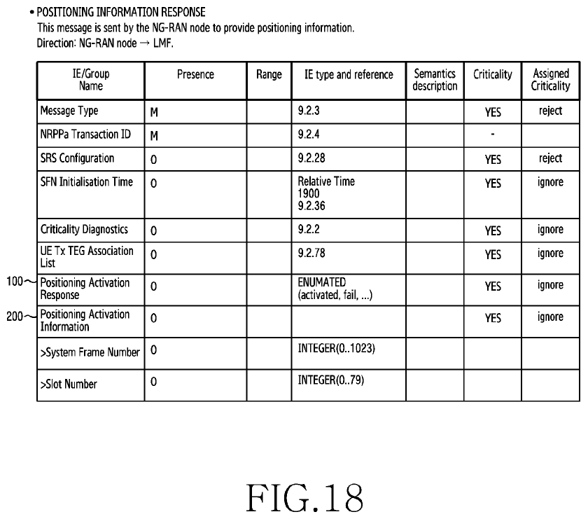

FIG. 18 illustrates a configuration of an NRPPa positioning information response message according to various embodiments of the present disclosure.

Referring to FIG. 18, FIG. 18 illustrates an example of a configuration of an NRPPa positioning information response message (for example, the message of operation 340 of FIG. 16) transferred to an LMF through an AMF. The name of the IE included in FIG. 18 is merely provided as an example, and another name having the same function may be also used. The NRPPa positioning information response message may include, in addition to information included in the existing NRPPa positioning information response message, a positioning activation response IE related to a result of a positioning activation request as indicated in 100, and the details of a result of processing of the activation request. In addition, as indicated in 200, the NRPPa positioning information response message may include information related to a positioning activation operation. In addition, the information related to the positioning response message is identical or similar to IE information included in the existing NRPPa positioning activation response message, and may thus include at least one of system frame number IE information and slot number IE information.

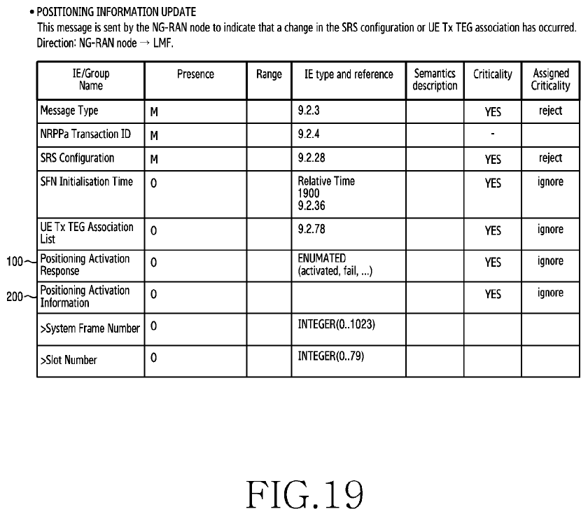

FIG. 19 illustrates a configuration of an NRPPa positioning information update message according to various embodiments of the present disclosure.

Referring to FIG. 19, FIG. 19 illustrates an example of a configuration of an NRPPa positioning information update message (for example, the message of operation 540 of FIG. 16) transferred to an LMF through an AMF. The name of the IE included in FIG. 19 is merely provided as an example, and another name having the same function may be also used. The NRPPa positioning information update message may include, in addition to information included in the existing NRPPa positioning information update message, a positioning activation response IE related to a result of a positioning activation request as indicated in 100, and the details of a result of processing of the activation request. In addition, as indicated in 200, the NRPPa positioning information update message may include information related to a positioning activation operation. In addition, the information related to the positioning response message is identical or similar to IE information included in the existing NRPPa positioning activation response message, and may thus include at least one of system frame number IE information and slot number IE information.

A flow of a signal for providing a positioning service by using an uplink SRS transmitted by a user equipment in an RRC inactive state is illustrated.

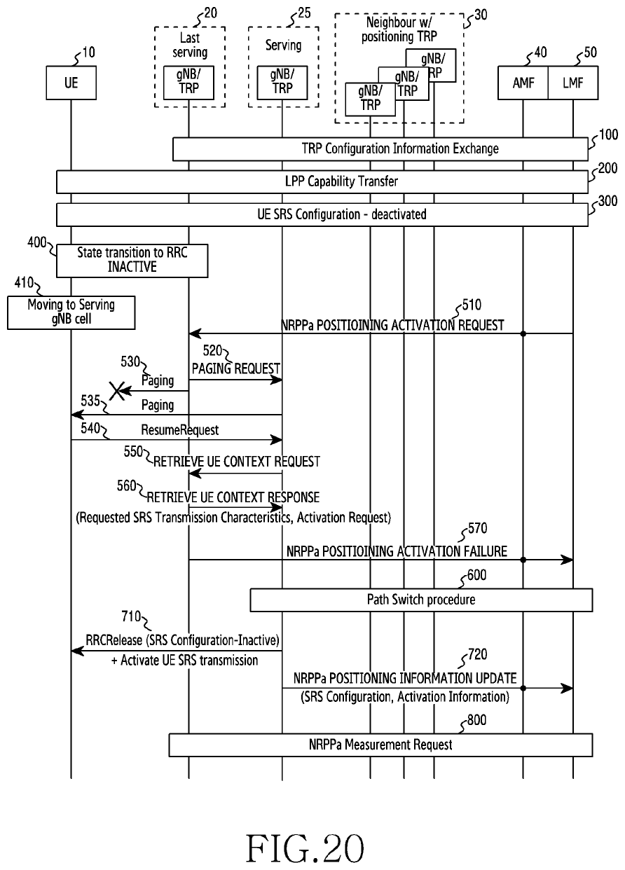

FIG. 20 illustrates an improved signal flow of a signal procedure in a procedure of transmitting an NRPPa positioning activation request to a last serving base station by an LMF in an RRC inactive state according to various embodiments of the present disclosure.

Referring to FIG. 20, a method for improving an inefficient signal procedure in relation to a case where an LMF transmits an NRPPa positioning activation request to a last serving base station in an RRC inactive state may be described. In the existing method, when the user equipment changes a serving cell in the RRC inactive state, the LMF rejects an NRPPa positioning activation request for a positioning service of the corresponding user equipment to the last serving base station, and if required, after the LMF performs a RAN paging procedure and then transmits an NRPPa positioning activation request to a serving base station to which the user equipment is currently connected, the serving base station indicates activation of uplink SRS transmission to the user equipment. In FIG. 20, a method for calculating the above-described existing procedure may be included.

In operation 100, the LMF 50 may perform a procedure of receiving information on a TRP for a positioning service from base stations 20 and 30 (for example, NR gNB or LTE eNB), and messages required for a procedure of receiving the information on the TRP for the positioning service may be transmitted and/or received through the AMF 40.

In operation 200, the LMF 50 may request positioning capability information of the user equipment 10 through an LPP capability transfer procedure with the user equipment 10, and receive positioning capability information from the user equipment 10.

In operation 300, the user equipment 10 may perform a procedure related to uplink SRS transmission configuration in the state in which the user equipment is connected with the last serving base station 20, and may perform a positioning monitoring procedure related to uplink SRS measurement when there is activated uplink SRS transmission configuration in the procedure related to the uplink SRS transmission configuration. However, with respect to deactivated uplink SRS transmission configuration, the user equipment 10, the base station, the LMF 50 may store configuration information without a positioning monitoring procedure, and the user equipment 10 may not perform configured uplink SRS transmission.

In operation 400, the last serving base station 20 may determine to cause the user equipment 10 to transition to an RRC inactive state.

In operation 410, the user equipment 10 may move to a cell of the serving base station 25.

In operation 510, the LMF 50 may transmit an NRPPa positioning activation request message to the lasting serving base station 20 through the AMF 40 to request activation for deactivated uplink SRS configuration.

When the last serving base station 20 having received the NRPPa positioning activation request message identifies that the user equipment 10 is ins the RRC inactive state, the last serving base station may transmit an RRC paging message to the user equipment 10 in operation 530, and may transmit an Xn paging request message to a neighboring base station 30 and request paging for the user equipment in operation 520.

In operation 535, base stations 30 having received the Xn paging request message may transfer the RRC paging message to the user equipment 10.

In operation 540, when the user equipment 10 receives the paging message in a moved cell (for example, when the user equipment 10 receives the RRC paging message transmitted by the serving base station 25 in operation 535), the user equipment 10 may transmit an RRC resume request message to the serving base station 25. The serving base station 25 having received the RRC resume request message from the user equipment 10 may search for, based on information included in the RRC resume request message, a last serving base station in which context of the user equipment 10 is stored.

In operation 550, the serving base station 25 may transmits an Xn retrieve UE context request message to the last serving base station 20.

In operation 560, the last serving base station 20 may transmit an Xn retrieve UE context response message including UE context to the serving base station 25. The last serving base station 20 may transmit the Xn retrieve UE context response message by including activation request-related information included in the NRPPa positioning activation request message received from the LMF 50 in operation 510. In addition, the last serving base station 20 may transmit the message by including requested SRS transmission characteristics information related to an uplink SRS configuration received from the LMF 50 during the procedure of operation 300.

In operation 570, the last serving base station 20 may also transfer an NRPPa positioning activation failure message to the LMF 50 through the AMF 40, and the NRPPa positioning activation failure message may include cause information (For example, information such as “mobility in RRC inactive”) indicating that the user equipment may move and perform an activation procedure in a new serving base station in the RRC inactive state.

In operation 600, after performing a path switch procedure related to a cell change in an RRC inactive state in operation 600, the serving base station 25 may transmit an RRCRelease message to the user equipment 10 to cause the user equipment 10 to transition to the RRC inactive state in operation 710. In addition, the serving base station 25 may include, in the RRCRelease message, uplink SRS configuration information to be used for the positioning service by the user equipment 10 in the RRC inactive state, and may transfer activate UE SRS transmission information for requesting UE SRS transmission activation to the user equipment 10 by using a MAC CE according to the positioning activation request information received from the last serving base station 20 in operation 560.

In operation 720, the serving base station 25 may transmit an NRPPa positioning information update message to the LMF 50 through the AMF 40, and may transmit the NRPPa positioning information update message by including uplink SRS configuration information configured for the user equipment and activation information related to a positioning activation request from the LMF 50. An example of a configuration of the NRPPa positioning information update message transferred in operation 720 may be identical to the example of the configuration of the message included in FIG. 19.

In operation 800, the LMF 50 may determine at least one of a base station, a cell, or a TRP 20, 25, or 30 for monitoring an uplink SRS transmitted by the user equipment, and may request uplink SRS monitoring of the user equipment from each base station through the AMF 40 by using an NRPPa measurement request procedure. In addition, the LMF 50 may receive a result of measurement of an uplink SRS, and calculate location information of the user equipment, based on the received information.

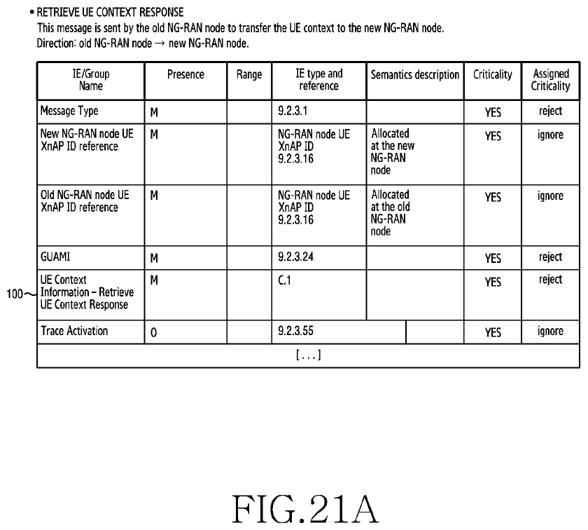

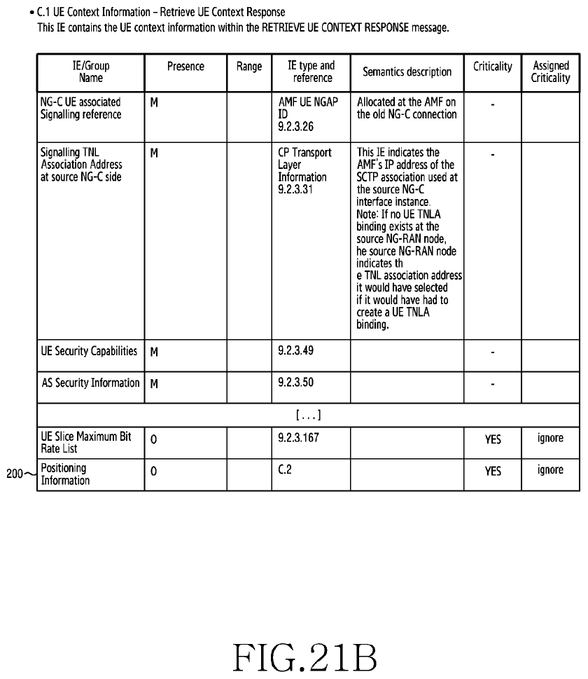

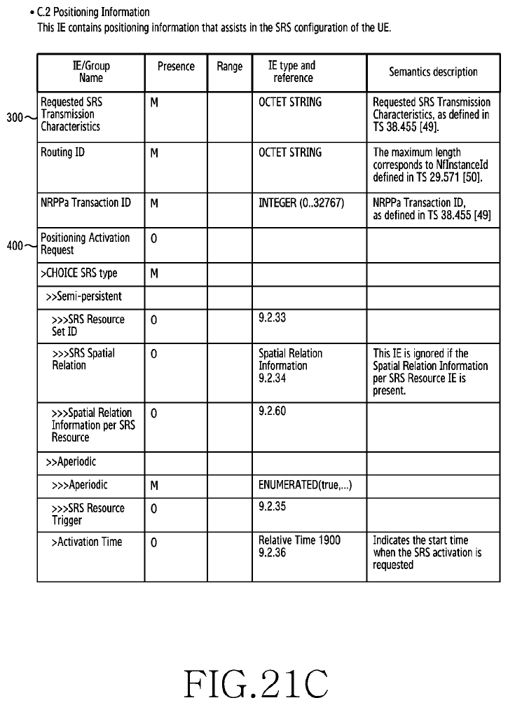

FIG. 21A illustrates a configuration of an Xn retrieve UE context response message according to various embodiments of the disclosure, FIG. 21B illustrates a configuration of an Xn retrieve UE context response message according to various embodiments of the disclosure, and FIG. 21C illustrates a configuration of an Xn retrieve UE context response message according to various embodiments of the present disclosure.

Referring to FIGS. 21A to 21C, FIGS. 21A to 21C illustrate a configuration of an Xn retrieve UE context response message (for example, the message of operation 560 of FIG. 20) transferred to a serving base station by a last serving base station. The name of the IE included in FIGS. 21A to 21C is provided as an example, and another name having the same function may be also used. The Xn retrieve UE context response message may include positioning activation request-related information in addition to information included in the existing Xn retrieve UE context response message.

As indicated in 100, the Xn retrieve UE context response message may include a UE context information—retrieve UE context response IE for including UE context information, and the UE context information—retrieve UE context response IE may include a positioning information IE which can include positioning-related information as indicated in 200. The positioning information IE may include at least one of a routing ID IE related to positioning procedure and service, and an NRPPa transaction ID, in addition to a requested SRS transmission characteristics IE for an uplink SRS configuration request as indicated in 300. In addition, as indicated in 400, a positioning activation request IE related to a positioning activation request may be further included, and the positioning activation request IE may include activation request information related to semi-persistent uplink SRS transmission or activation request information related to aperiodic uplink SRS transmission. Each activation request-related information is identical or similar to IE information included in the existing NRPPa positioning activation request message, and each activation request-related information may include SRS resource set ID and SRS spatial relation, or spatial relation information per SRS resource-related IE information in a case of semi-persistent. In addition, in a case of aperiodic, each activation request-related information may include an aperiodic operation indicator or SRS resource trigger IE information. In addition, each activation request-related information may include activation time IE information.

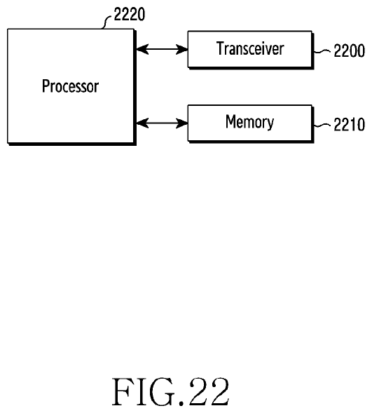

FIG. 22 illustrates an internal structure of a base station according to various embodiments of the present disclosure.

Referring to FIG. 22, a base station may include a transceiver 2220, a storage (or memory) 2210, and/or a controller (or processor) 2220. The transceiver 2200, the storage 2210, and/or the controller 2220 may operate according to the above-described base station communication method. A network device may also correspond to the structure of the base station. However, the elements of the base station are not limited to the above-described example. For example, the base station may include more or fewer elements than the above-described elements. For example, the base station may include the transceiver 2200 and the controller 2220. In addition, the transceiver 2200, the storage 2210, and/or the controller 2220 may be implemented in the form of a chip. In addition, the base station may be separated as multiple network devices (for example, including at least one of a central unit (CU), a distributed unit (DU), or a remote unit (RU)).

The transceiver 2200 is a term collectively referring to a reception unit of the base station and a transmission unit of the base station, and may transmit or receive a signal with a user equipment, other base stations, or other network devices. In this case, the transmitted or received signal may include control information or data. For example, the transceiver 2200 may transmit system information to the terminal, and transmit a synchronization signal or a reference signal. To this end, the transceiver 2200 may include an RF transmitter for up-converting and amplifying the frequency of the transmitted signal, an RF receiver for low-noise amplifying the received signal and down-converting the frequency, etc. However, this is an embodiment of the transceiver 2200, and the elements of the transceiver 2200 are not limited to the RF transmitter and the RF receiver. The transceiver 2200 may include a wired/wireless transceiver, and may include various elements for transmitting or receiving signals. In addition, the transceiver 2200 may receive a signal through a communication channel (for example, wireless channel) and output the same to the controller 2220, and may transmit the signal output from the controller 2220 through the channel. In addition, the transceiver 2200 may receive a communication signal and output the same to the processor, and may transmit the signal output from the processor to a terminal, another base station, or another entity through a wired/wireless network.

The storage 2210 may store a program and data required for the operation of the base station. The storage 2210 may be also referred to as memory. In addition, the storage 2210 may store control information or data included in the signal acquired from the base station. The storage 2210 may be configured as a storage medium such as a ROM, a RAM, a hard disc, a CD-ROM, and a DVD, or a combination of storage media. In addition, the storage 2210 may store at least one of information transmitted or received through the transceiver 2200 and information generated through the controller 2220.

In the disclosure, the controller 2220 may be defined as a circuit, an application-specific integrated circuit, or at least one processor. The controller 2220 may be also referred to as processor. The processor may include a communication processor (CP) performing control for communication and an application processor (AP) for controlling an upper layer such as application program. The controller 2220 may control the overall operation of the base station according to the embodiment provided in the disclosure. For example, the controller 2220 may control a flow of a signal between blocks to perform the operation according to the above-described flow chart.

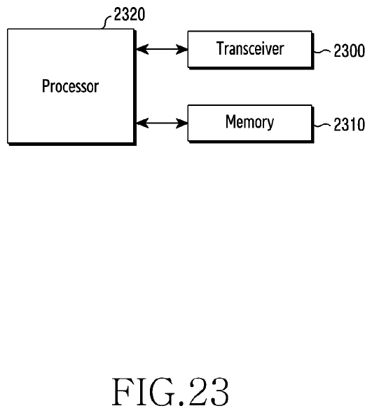

FIG. 23 illustrates a configuration of a terminal according to various embodiments of the present disclosure.

Referring to FIG. 23, a terminal may include a transceiver 2300, a storage (or memory) 2310, and/or a controller (or processor) 2320. The transceiver 2300, the storage 2310, and/or the controller 2320 may operate according to the above-described terminal communication method. However, the elements of the terminal are not limited to the above-described example. For example, the terminal may include more or fewer elements than the above-described elements. For example, the terminal may include the transceiver 2300 and the controller 2320. In addition, the transceiver 2300, the storage 2310, and/or the controller 2320 may be implemented in the form of a chip.

The transceiver 2300 is a term collectively referring to a reception unit of the terminal and a transmission unit of the terminal, and may transmit or receive a signal with a base station, another terminal, or a network entity. The signal transmitted or received to or from the base station may include control information or data. For example, the transceiver 2300 may receive system information from the base station, and receive a synchronization signal or a reference signal. To this end, the transceiver 2300 may include an RF transmitter for up-converting and amplifying the frequency of the transmitted signal, an RF receiver for low-noise amplifying the received signal and down-converting the frequency, etc. However, this is an embodiment of the transceiver 2300, and the elements of the transceiver 2300 are not limited to the RF transmitter and the RF receiver. In addition, the transceiver 2300 may include a wired/wireless transceiver, and may include various elements for transmitting or receiving signals. In addition, the transceiver 2300 may receive a signal through a wireless channel and output the same to the controller 2320, and may transmit the signal output from the controller 2320 through the wireless channel. In addition, the transceiver 2300 may receive a communication signal and output the same to the processor, and may transmit the signal output from the processor through a wired/wireless network.

The storage 2310 may store a program and data required for the operation of the terminal. The storage 2310 may be also referred to as memory. In addition, the storage 2310 may store control information or data included in the signal acquired from the terminal. The storage 2310 may be configured as a storage medium such as a ROM, a RAM, a hard disc, a CD-ROM, and a DVD, or a combination of storage media.

In the disclosure, the controller 2320 may be defined as a circuit, an application-specific integrated circuit, or at least one processor. The controller 2320 may be also referred to as processor. The processor may include a communication processor (CP) performing control for communication and an application processor (AP) for controlling an upper layer such as application program. The controller 2320 may control the overall operation of the terminal according to the embodiment provided in the disclosure. For example, the controller 230 may control a flow of a signal between blocks to perform the operation according to the above-described flow chart.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a provided situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the FDD LTE system, other variants based on the technical idea of the above embodiments may also be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the sake of illustration, and embodiments of the disclosure are not limited to the embodiments set forth herein. Those skilled in the art will appreciate that the disclosure may be easily modified and changed into other specific forms without departing from the technical idea or essential features of the disclosure. Therefore, the scope of the disclosure should be determined not by the above detailed description but by the appended claims, and all modification sand changes derived from the meaning and scope of the claims and equivalents thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a location management function (LMF) entity in a wireless communication system, the method comprising:
identifying a validity area associated with requested sounding reference signal (SRS) configuration information for a user equipment (UE);
transmitting, to a first base station, a first message including information on the validity area; and
receiving, from the first base station, a second message including the SRS configuration information associated with the validity area.

2. The method of claim 1, further comprising:
transmitting, to at least one second base station, at least one of the information on the validity area or the SRS configuration information,
wherein the first base station is a serving base station for the UE,
wherein the at least one second base station excludes the first base station, and
wherein the first base station and the at least one second base station are located in the validity area.

3. The method of claim 1, wherein the second message further includes information on a validity area configured to the UE.

4. The method of claim 1, wherein the information on the validity area includes a cell list.

5. The method of claim 4, wherein the cell list is for at least one cell included in the validity area, and
wherein the SRS configuration information is applied to the UE in the validity area.

6. A method performed by a first base station in a wireless communication system, the method comprising:
receiving, from a location management function (LMF) entity, a first message including information on a validity area associated with requested sounding reference signal (SRS) configuration information for a user equipment (UE);
transmitting, to the UE, a second message including the SRS configuration information associated with the validity area; and
transmitting, to the LMF entity, a third message including the SRS configuration information associated with the validity area.

7. The method of claim 6, wherein the first base station is a serving base station for the UE,
wherein at least one second base station excludes the first base station,
wherein at least one second base station receives at least one of the information on the validity area or the SRS configuration information from the first base station, and
wherein the first base station and the at least one second base station are located in the validity area.

8. The method of claim 6, wherein the third message further includes information on a validity area configured to the UE.

9. The method of claim 6, wherein the information on the validity area includes a cell list.

10. The method of claim 9, wherein the cell list is for at least one cell included in the validity area, and
wherein the SRS configuration information is applied to the UE in the validity area.

11. A location management function (LMF) entity in a wireless communication system, the LMF entity comprising:
a transceiver; and
at least one controller coupled with the transceiver and configured to:
identify a validity area associated with requested sounding reference signal (SRS) configuration information for a user equipment (UE),
transmit, to a first base station, a first message including information on the validity area, and
receive, from the first base station, a second message including the SRS configuration information associated with the validity area.

12. The LMF entity of claim 11, wherein the at least one controller is further configured to:
transmit, to at least one second base station, at least one of the information on the validity area or the SRS configuration information,
wherein the first base station is a serving base station for the UE,
wherein the at least one second base station excludes the first base station, and
wherein the first base station and the at least one second base station are in the validity area.

13. The LMF entity of claim 11, wherein the second message further includes information on a validity area located configured to the UE.

14. The LMF entity of claim 11, wherein the information on the validity area includes a cell list.

15. The LMF entity of claim 14, wherein the cell list is for at least one cell included in the validity area, and
wherein the SRS configuration information is applied to the UE in the validity area.

16. A first base station in a wireless communication system, the first base station comprising:
a transceiver; and
at least one controller coupled with the transceiver and configured to:
receive, from a location management function (LMF) entity, a first message including information on a validity area associated with requested sounding reference signal (SRS) configuration information for a user equipment (UE),
transmit, to the UE, a second message including the SRS configuration information associated with the validity area, and
transmit, to the LMF entity, a third message including the SRS configuration information associated with the validity area.

17. The first base station of claim 16, wherein the first base station is a serving base station for the UE,
wherein at least one second base station excludes the first base station,
wherein at least one second base station receives at least one of the information on the validity area or the SRS configuration information from the first base station, and
wherein the first base station and the at least one second base station are located in the validity area.

18. The first base station of claim 16, wherein the third message further includes information on a validity area configured to the UE.

19. The first base station of claim 16, wherein the information on the validity area includes a cell list.

20. The first base station of claim 19, wherein the cell list is for at least one cell included in the validity area, and
wherein the SRS configuration information is applied to the UE in the validity area.
